(19) United States
(12) Patent Application Publication
(10) Pub. No.: US 2018/0272585 A1
(43) Pub. Date: Sep. 27, 2018

(54) METHOD OF PRODUCING MOLDED PRODUCT, MOLDED PRODUCT, CARTRIDGE, AND IMAGE FORMING APPARATUS

(71) Applicant: CANON KABUSHIKI KAISHA, Tokyo (JP)

(72) Inventors: Kazuhiro Kochi, Yokohama-shi (JP); Daigo Kobayashi, Tokyo (JP); Masaaki Udagawa, Tsukuba-shi (JP); Yohei Doi, Yokohama-shi (JP); Masaru Nabeshima, Chigasaki-shi (JP); Haruyasu Ishikawa, Yokohama-shi (JP); Akihiro Baba, Ichikawa-shi (JP); Daisuke Sannohe, Tokyo (JP)

(21) Appl. No.: 15/922,004

(22) Filed: Mar. 15, 2018

(30) Foreign Application Priority Data
Mar. 21, 2017 (JP) 2017-055121
Apr. 28, 2017 (JP) 2017-090729
Dec. 22, 2017 (JP) 2017-247055

(51) Int. Cl. B29C 45/56; B29C 45/14; B29C 45/00; B29C 45/27

(52) U.S. Cl. CPC B29C 45/561; B29C 45/1418; B29C 45/14631; G03G 15/0896; B29C 45/2708; G03G 21/1853; B29C 45/0001

(57) ABSTRACT

A method of producing a molded product includes preparing a mold for insert molding in which a cavity corresponding to a molded product including a trunk portion and an arm portion is defined, disposing an insert member including a bent portion and a first extending portion extending from the bent portion in a state in which one side of the insert member is supported in the cavity such that the first extending portion is downstream of the bent portion in a flow direction of molten resin, wherein the mold includes, on a wall surface defining a space corresponding to the arm portion in the cavity, a first projecting portion that supports a part of a surface of the first extending portion positioned on a major angle side of the bent portion, and injecting molten resin into the cavity.

### BACKGROUND OF THE INVENTION

### Field of the Invention

The present invention relates to insert molding.

### Description of the Related Art

A technique called insert molding is known. In insert molding, in order to improve the rigidity and creep strength of a molded product, an insert member such as a metal member is disposed in a cavity in a mold, and the insert member is coated with a resin member by injecting molten resin around the insert member.

Japanese Patent No. 4705829 discloses a resin panel including an insert member, and a reinforcing member extending linearly in a longitudinal direction is disclosed as the insert member. Particularly, in Japanese Patent No. 4705829, by supporting both ends of the reinforcing member in the longitudinal direction by a support member and holding an end portion of the reinforcing member in a width direction by a mold holding portion, the reinforcing member is prevented from being displaced by injection pressure of molten resin at the time of molding.

The form of displacement of the insert member varies depending on, for example, the shape of the molded product, and it has been conventionally desired that insert molding is performed in a state in which the insert member is held at a desired position as described above.

### SUMMARY OF THE INVENTION

According to a first aspect of the present invention, a method of producing a molded product includes preparing a mold for insert molding which includes a plurality of molds and in which a cavity corresponding to a molded product including a trunk portion and an arm portion extending from the trunk portion is defined, disposing an insert member including a bent portion and a first extending portion extending from the bent portion in a state in which one side of the insert member is supported in the cavity such that the first extending portion is downstream of the bent portion in a flow direction of molten resin, wherein the mold includes, on a wall surface defining a space corresponding to the arm portion in the cavity, a first projecting portion that supports a part of a surface of the first extending portion positioned on a major angle side of the bent portion, and injecting molten resin into the cavity in a state in which the part of the surface of the first extending portion positioned on the major angle side of the bent portion is supported by the first projecting portion.

According to a second aspect of the present invention, a molded product includes a trunk portion including a first metal portion and a first resin portion, and an arm portion extending from the trunk portion and including a second metal portion and a second resin portion, the second metal portion extending from the first metal portion. The second metal portion includes a bent portion and a first extending portion extending from the bent portion toward a distal end side of the arm portion. The arm portion includes a first exposing portion that exposes a part of a surface of the first extending portion positioned on a major angle side of the bent portion.

Further features of the present invention will become apparent from the following description of exemplary embodiments with reference to the attached drawings.

### BRIEF DESCRIPTION OF THE DRAWINGS

FIG. 1 is an explanatory diagram illustrating a schematic configuration of an image forming apparatus according to a first exemplary embodiment.

FIG. 2 is a perspective view of a cartridge to be attached to an image forming apparatus body according to the first exemplary embodiment.

FIG. 3 is a perspective view of a transmission member serving as an example of a molded product according to the first exemplary embodiment.

FIG. 4A is a partial perspective view of the transmission member according to the first exemplary embodiment.

FIG. 4B is a section view of the transmission member according to the first exemplary embodiment.

FIG. 5 is an explanatory diagram illustrating a production apparatus for producing the transmission member according to the first exemplary embodiment.

FIG. 6A is partial perspective view of a pressed hoop material according to the first exemplary embodiment.

FIG. 6B is a partial plan view of the pressed hoop material according to the first exemplary embodiment.

FIG. 7A is a schematic diagram for describing a production process of the transmission member by insert molding according to the first exemplary embodiment.

FIG. 7B is a schematic diagram for describing the production process of the transmission member by insert molding according to the first exemplary embodiment.

FIG. 7C is a schematic diagram for describing the production process of the transmission member by insert molding according to the first exemplary embodiment.

FIG. 8A is a perspective view of a metal member disposed in a mold according to the first exemplary embodiment.

FIG. 8B is a section view of a pair of molds taken along a line VIIIB of FIG. 8A illustrating a state in which the pair of molds are clamped.

FIG. 9A is an explanatory diagram illustrating a state in which molten resin is being injected into a space corresponding to an arm portion in a cavity according to the first exemplary embodiment.

FIG. 9B is an explanatory diagram illustrating a state in which the molten resin is being injected into the space corresponding to the arm portion in the cavity according to the first exemplary embodiment.

FIG. 9C is an explanatory diagram illustrating a state in which the molten resin is being injected into the space corresponding to the arm portion in the cavity according to the first exemplary embodiment.

FIG. 10A is a section view of a space for forming an arm portion in a cavity of a mold for forming a transmission member serving as an example of a molded product according to a second exemplary embodiment.

FIG. 10B is a section view of the arm portion of the transmission member according to the second exemplary embodiment.

FIG. 11A is a section view of a space for forming an arm portion in a cavity of a mold for forming a transmission member serving as an example of a molded product according to a third exemplary embodiment.

FIG. 11B is a section view of the arm portion of the transmission member according to the third exemplary embodiment.

FIG. 12A is a partial perspective view of an arm portion of a transmission member serving as an example of a molded product according to a fourth exemplary embodiment.

FIG. 12B is a section view of the arm portion taken along a line XIIB of FIG. 12A.

FIG. 12C is a section view of the arm portion taken along a line XIIC of FIG. 12A.

FIG. 12D is a section view of a portion of a mold corresponding to the arm portion illustrated in FIG. 12B.

FIG. 12E is a section view of a portion of the mold corresponding to the arm portion illustrated in FIG. 12C.

FIG. 13A is a plan view of an arm portion of a transmission member serving as an example of a molded product according to a fifth exemplary embodiment.

FIG. 13B is a section view of the arm portion taken along a line XIIIB of FIG. 13A.

FIG. 13C is a section view of a portion of a mold corresponding to the arm portion illustrated in FIG. 13B.

FIG. 14A is a perspective view of a transmission member serving as an example of a molded product according to a sixth exemplary embodiment.

FIG. 14B is a section view of the transmission member according to the sixth exemplary embodiment.

FIG. 15A is a plan view of the transmission member according to the sixth exemplary embodiment.

FIG. 15B is a section view of the transmission member according to the sixth exemplary embodiment.

FIG. 16A is a section view of an arm portion taken along a line XVIA of FIG. 15A.

FIG. 16B is a section view of the arm portion taken along a line XVIB of FIG. 15B.

FIG. 17A is an explanatory diagram of attachment of the transmission member according to the sixth exemplary embodiment to a drive shaft.

FIG. 17B is an explanatory diagram of attachment of the transmission member according to the sixth exemplary embodiment to the drive shaft.

FIG. 18 is a plan view of a transmission member serving as an example of a molded product according to a seventh exemplary embodiment.

FIG. 19 is a plan view of the transmission member according to the seventh exemplary embodiment.

FIG. 20 is a perspective view of the transmission member according to the seventh exemplary embodiment.

FIG. 21 is a perspective view of a transmission member serving as an example of a molded product according to an eighth exemplary embodiment.

FIG. 22 is a partial perspective view of the transmission member according to the eighth exemplary embodiment.

FIG. 23 is a section view of a cutting machine according to the eighth exemplary embodiment.

FIG. 24 is a perspective view of a transmission member serving as an example of a molded product according to a ninth exemplary embodiment.

FIG. 25 is a section view of the transmission member taken along a line XXV of FIG. 24.

FIG. 26 is a partial perspective view of a hoop material according to the ninth exemplary embodiment.

FIG. 27 is a perspective view of a metal member disposed in a mold according to the ninth exemplary embodiment.

FIG. 28A is a section view of the mold taken along a line XXVIII of FIG. 27.

FIG. 28B is a section view of the mold taken along the line XXVIII of FIG. 27.

FIG. 28C is a section view of the mold taken along the line XXVIII of FIG. 27.

FIG. 29A is a schematic diagram illustrating a process of producing the transmission member according to the ninth exemplary embodiment by injection molding.

FIG. 29B is a schematic diagram illustrating the process of producing the transmission member according to the ninth exemplary embodiment by injection molding.

FIG. 29C is a schematic diagram illustrating the process of producing the transmission member according to the ninth exemplary embodiment by injection molding.

FIG. 30 is a partial perspective view of the hoop material according to the ninth exemplary embodiment.

FIG. 31 is a perspective view of the metal member disposed in the mold according to the ninth exemplary embodiment.

FIG. 32 is a graph showing a result of experiment according to the ninth exemplary embodiment.

FIG. 33 is a perspective view of metal members of a modification example.

FIG. 34 is a plan view of a hoop material according to a tenth exemplary embodiment.

FIG. 35A is a perspective view of the hoop material according to the tenth exemplary embodiment.

FIG. 35B is a plan view of the hoop material according to the tenth exemplary embodiment.

### DESCRIPTION OF THE EMBODIMENTS

Hereinafter, exemplary embodiments for implementing the present invention will be described in detail with reference to drawings.

### First Exemplary Embodiment

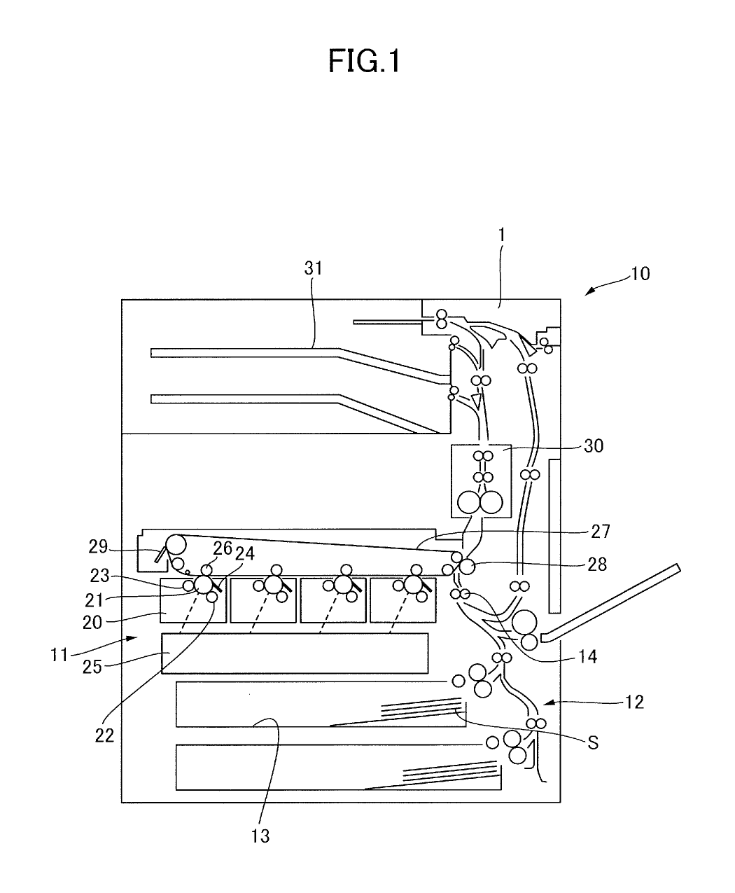

FIG. 1 is an explanatory diagram illustrating a schematic configuration of an image forming apparatus according to a first exemplary embodiment. An image forming apparatus 10 is a full-color printer that employs an electrophotographic system. The image forming apparatus includes an image forming portion 11 and a conveyance portion 12 that conveys a sheet S. The image forming portion 11 has a configuration of a so-called tandem type in which a plurality of cartridges 20 are arranged in a moving direction of an intermediate transfer belt 27. In the present exemplary embodiment, four cartridges 20 are provided. The cartridges 20 are process cartridges for image formation that respectively form toner images of yellow, magenta, cyan, and black.

The cartridges 20 are attachable to and detachable from an image forming apparatus body 1. Since the cartridges 20 each have the same configuration, description will be given for the cartridge 20 illustrated at the left end in FIG. 1, and reference signs and descriptions for the other cartridges will be omitted.

The cartridge 20 includes a photosensitive drum 21, a charging roller 22, a developing unit 23, and a drum cleaner 24. The photosensitive drum 21 is rotationally driven at a predetermined process speed by an unillustrated drum motor disposed in the image forming apparatus body 1. The surface of the photosensitive drum 21 is uniformly charged by the charging roller 22. The charged surface of the photosensitive drum 21 is irradiated with a laser beam by a scanner unit 25 on the basis of image information, and thus an electrostatic latent image is formed thereon. The electrostatic latent image on the photosensitive drum 21 is developed as a toner image by attaching toner thereto by the developing unit 23. The toner image on the photosensitive drum 21 is transferred onto the intermediate transfer belt 27 through primary transfer by applying a primary transfer bias between a primary transfer roller 26 and the photosensitive drum 21. Transfer residual toner remaining on the photosensitive drum 21 after the transfer is removed by the drum cleaner 24.

As a result of such a process being performed in each of the cartridges 20, toner images of respective colors formed on photosensitive drums 21 of the respective cartridges 20 are transferred onto the intermediate transfer belt 27 so as to be superimposed on one another, and thus a full-color toner image is formed on the intermediate transfer belt 27. The toner image on the intermediate transfer belt 27 is transferred, through secondary transfer and by a secondary transfer portion constituted by the intermediate transfer belt 27 and a secondary transfer roller 28, onto a sheet S conveyed by the conveyance portion 12. Toner remaining on the intermediate transfer belt 27 after the transfer is removed by a belt cleaner 29.

The conveyance portion 12 is constituted by a plurality of conveyance rollers, picks up a sheet S accommodated in a cassette 13, and conveys the sheet S to the secondary transfer portion of the image forming portion 11. The conveyance of the sheet S to the secondary transfer portion is performed by a registration roller pair 14 at a timing matching the conveyance of the toner image on the intermediate transfer belt 27. The sheet S onto which the toner image has been transferred by the secondary transfer portion is heated and pressurized by a fixing unit 30, and thus the toner image is fixed. The sheet S to which the toner image has been fixed is discharged onto a discharge tray 31.

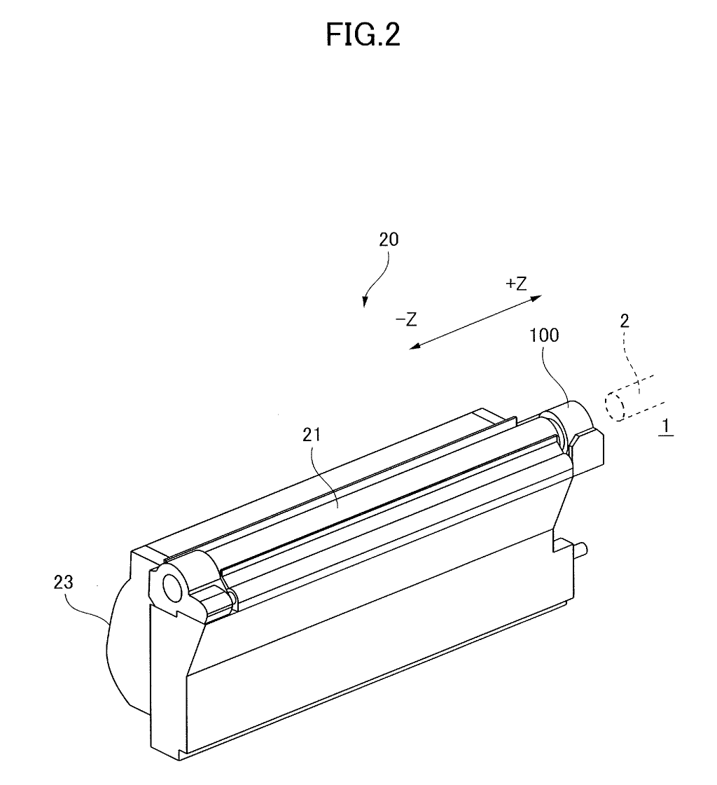

FIG. 2 is a perspective view of the cartridge 20 to be attached to the image forming apparatus body 1 according to the first exemplary embodiment. The photosensitive drum 21 includes a cylindrical member extending in a ±Z direction that is a longitudinal direction and formed of, for example, aluminum, and a photosensitive layer formed on the surface of the cylindrical member. A transmission member 100 is attached to an end portion of the photosensitive drum 21 in the longitudinal direction. Rotational force of the unillustrated drum motor of the image forming apparatus body 1 is transmitted through the transmission member 100. The transmission member 100 is configured to be engaged with or disengaged from a drive shaft 2 provided on the image forming apparatus body 1 when a user attaches or detaches the cartridge 20 to or from the image forming apparatus body 1. For example, in the case of attaching the cartridge 20 to the image forming apparatus body 1, the transmission member 100 is engaged with the drive shaft 2 by moving the cartridge 20 in the +Z direction while arranging the transmission member 100 and the drive shaft 2 coaxially in FIG. 2. In the case of detaching the cartridge 20 from the image forming apparatus body 1, the transmission member 100 is disengaged from the drive shaft 2 by moving the cartridge 20 in the −Z direction in FIG. 2.

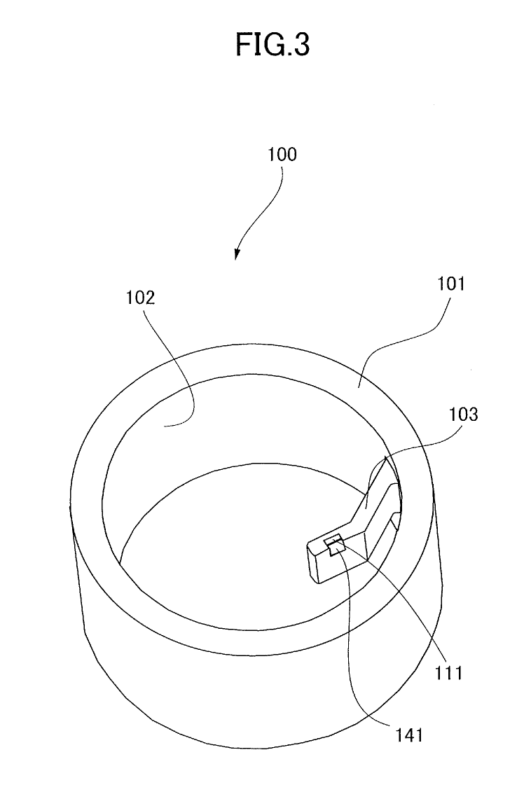

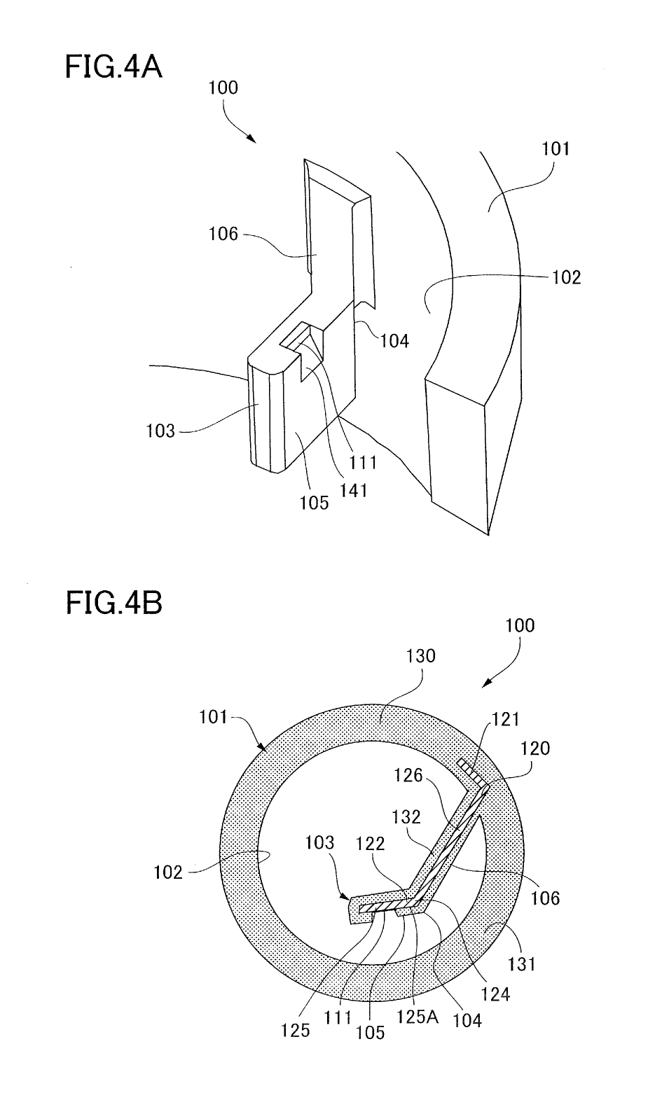

FIG. 3 is a perspective view of the transmission member 100 serving as an example of a molded product in the first exemplary embodiment. FIG. 4A is a partial perspective view of the transmission member 100. FIG. 4B is a section view of the transmission member 100.

The transmission member 100 includes a trunk portion 101 having a cylindrical shape and an arm portion 103 extending from an inner circumferential surface 102 of the trunk portion 101. When the cartridge 20 is attached to the image forming apparatus body 1, the arm portion 103 of the transmission member 100 is engaged with an unillustrated groove portion of the drive shaft 2 of the image forming apparatus body 1. When the cartridge 20 is detached from the image forming apparatus body 1, the arm portion 103 of the transmission member 100 is disengaged from the unillustrated groove portion of the drive shaft 2 of the image forming apparatus body 1. The thickness of the trunk portion 101 is, for example, about 1.5 mm. The thickness of the arm portion 103 is, for example, about 0.9 mm.

The transmission member 100 in the first exemplary embodiment is produced by insert molding. The transmission member 100 is a molded product constituted by a metal member 120 and a resin member 130 integrally provided with the metal member 120. The metal member 120 is provided as reinforcement for ensuring the rigidity and creep strength of the arm portion 103, and serves as an example of an insert member. The metal member 120 is formed by, for example, processing a plate of metal such as stainless steel. The width of the metal member 120 is, for example, about 4.3 mm, and the thickness thereof is, for example, about 0.2 mm. The resin member 130 is a member of thermoplastic resin, and is a plastic material of, for example, polyoxymethylene: POM.

The metal member 120 includes a metal portion 121 and a metal portion 122 extending from the metal portion 121. The metal portion 121 is a constituent of the trunk portion 101 and serves as a first metal portion. The metal portion 122 is a constituent of the arm portion 103 and serves as a second metal portion. The resin member 130 includes resin portions 131 and 132. The resin portion 131 is a constituent of the trunk portion 101 and serves as a first resin portion integrally provided with the metal portion 121. The resin portion 132 is a constituent of the arm portion 103 and serves as a second resin portion integrally provided with the metal portion 122. As described above, the metal member 120 is disposed to be present in both of the trunk portion 101 and the arm portion 103.

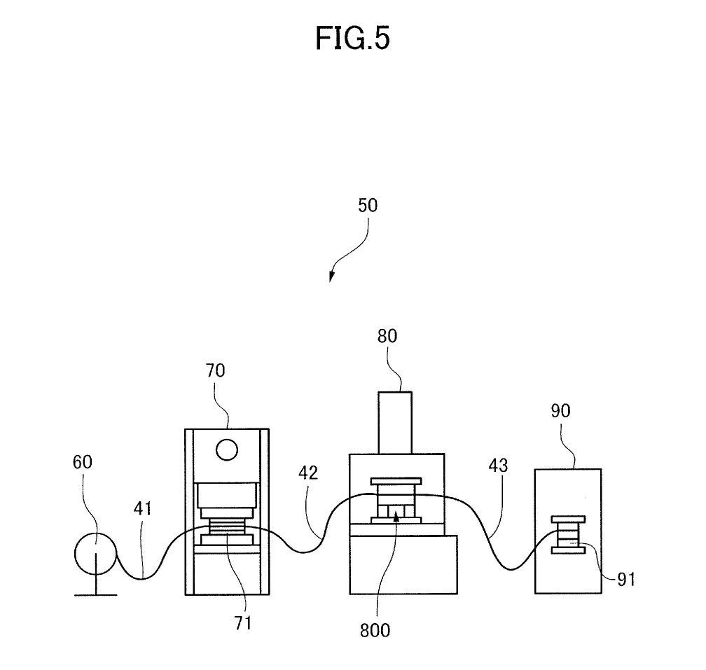

FIG. 5 is an explanatory diagram illustrating a production apparatus for producing the transmission member 100 according to the first exemplary embodiment. A production apparatus 50 illustrated in FIG. 5 is an apparatus that performs hoop molding, and includes an uncoiler 60, a pressing machine 70, an injection molding machine 80, and a cutting machine 90.

The uncoiler 60 has a function of letting out a hoop material 41 that is a metal plate wound up into a roll shape. The hoop material 41 before press working let out by the uncoiler 60 is supplied to the pressing machine 70.

The pressing machine 70 includes a press progressive die 71, and the hoop material 41 before press working is supplied to the press progressive die 71 by an unillustrated material feeder. Press working is performed by using the press progressive die 71, and a pressed hoop material 42 is sequentially let out by an unillustrated let-out apparatus. The hoop material 42 is supplied to the injection molding machine 80.

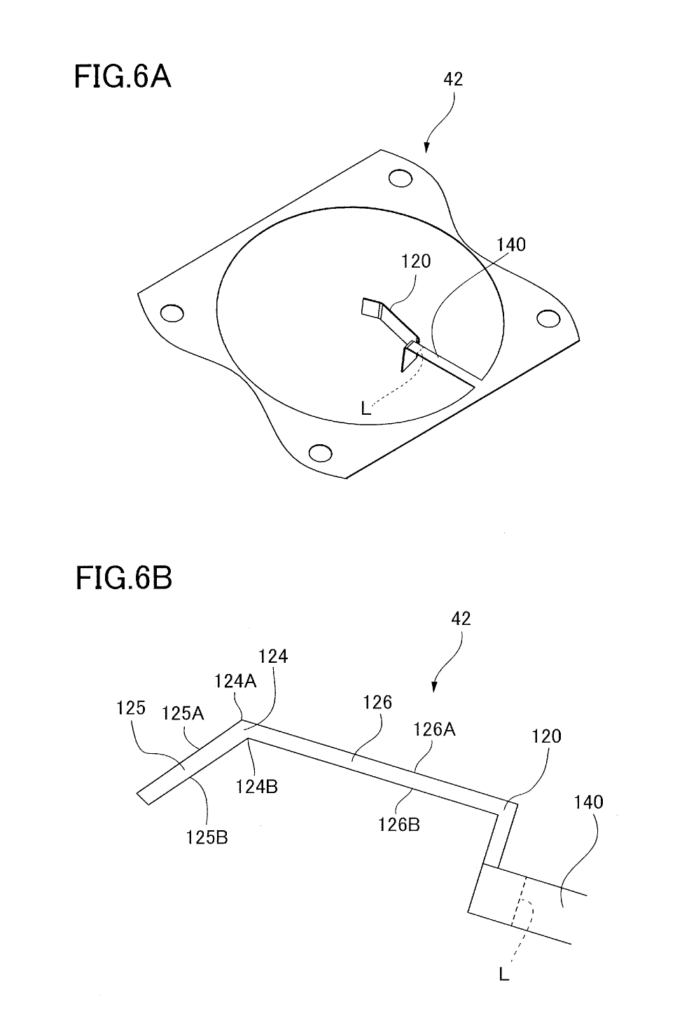

FIG. 6A is a partial perspective view of the pressed hoop material 42. FIG. 6B is a partial plan view of the pressed hoop material 42. As illustrated in FIGS. 6A and 6B, the pressed hoop material 42 includes the metal member 120 serving as an insert member and a constituent of the transmission member 100, and a support member 140 that supports one side of the metal member 120. To be noted, the metal member 120 and the support member 140 are cut apart along a broken line L of FIGS. 6A and 6B by the cutting machine 90 illustrated in FIG. 5 in a step after injection molding.

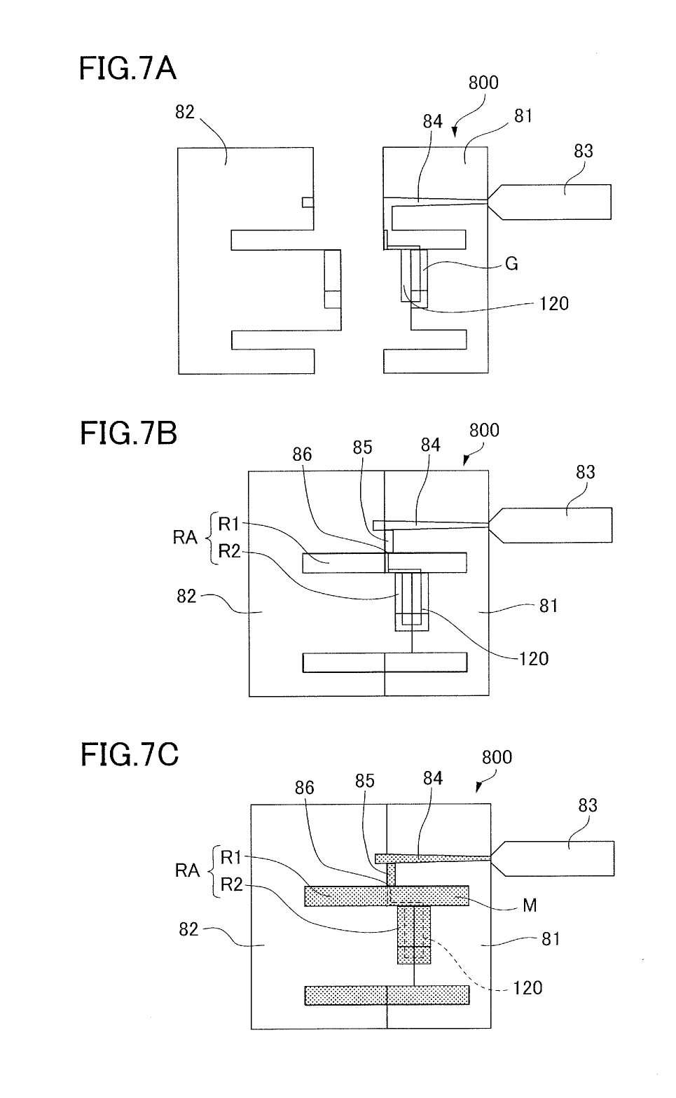

FIGS. 7A, 7B, and 7C are schematic diagrams for describing a production process of the transmission member 100 by insert molding according to the first exemplary embodiment. The injection molding machine 80 includes a mold for insert molding 800 provided with molds 81 and 82 as a plurality of molds. The mold 81 serving as a first mold is a fixed mold, and the mold 82 serving as a second mold is a movable mold. The injection molding machine 80 includes an unillustrated mold temperature adjusting device. The molds 81 and 82 include unillustrated flow paths, and are kept at a certain temperature by a fluid such as a liquid supplied from the unillustrated mold temperature adjusting device passing through the unillustrated flow path.

As illustrated in FIG. 7A, the mold 800 including the molds 81 and 82 is prepared. By conveying the hoop material 42 illustrated in FIG. 6A, the metal member 120 of the hoop material 42 is disposed between the molds 81 and 82 that are open, more specifically in a groove portion G serving as a cavity RA on the mold 81 in the first exemplary embodiment. As illustrated in FIG. 7B, the metal member 120 is disposed in the cavity RA between the molds 81 and 82 by clamping the molds 81 and 82 in a clamping step. The cavity RA is a space defined between the molds 81 and 82 by clamping the molds 81 and 82, and has a shape corresponding to the shape of the transmission member 100 to be formed. The cavity RA includes a space R1 and a space R2. The space R1 serves as a first space for forming the trunk portion 101. The space R2 communicates with the space R1, and serves as a second space for forming the arm portion 103 illustrated in FIG. 3. By clamping the molds 81 and 82, the support member 140 supporting one side of the metal member 120 is nipped between the molds 81 and 82 and is thus fixed. The metal member 120 is disposed so as to be present in both of the spaces R1 and R2 in a state in which one side thereof is supported by the support member 140. To be noted, in FIGS. 7A, 7B, and 7C, illustration of the support member 140 shown in FIG. 6A is omitted.

Next, as illustrated in FIG. 7C, molten resin M is injected from a plasticizing cylinder 83 into the cavity RA through a sprue 84, a runner 85, and a gate 86 in an injection step. The gate 86 is connected to the space R1 of the cavity RA, and the injected molten resin M flows to the space R2 through the space R1. To be noted, the position and number of the gate 86 may be determined such that the injection on the back surface of the metal member 120 is balanced.

The molten resin M is cooled and solidified in the cavity RA of the molds 81 and 82 in a cooling step, then the molds 81 and 82 are opened in an opening step, and the molded product is taken out by an unillustrated ejector pin. A hoop material 43 after molding illustrated in FIG. in which the metal member 120 molded with the resin member 130 illustrated in FIG. 3 is connected to the support member 140 is discharged from the injection molding machine 80 by the unillustrated let-out apparatus, and is conveyed to the cutting machine 90. The cutting machine 90 includes a cutting die 91, and cuts off the transmission member 100 illustrated in FIG. 3 from the hoop material 43 by using the cutting die 91. Thus, the transmission member 100 serving as the molded product can be obtained.

Here, as illustrated in FIG. 4B, the arm portion 103 includes a straight portion 106, a bent portion 104, and a straight portion 105 in this order from the proximal end connected to the trunk portion 101 to the distal end that is free. The metal member 120 serving as an insert member, more specifically the metal portion 122, includes a straight portion 126, a bent portion 124, and a straight portion 125 having shapes following the shape of the arm portion 103. The straight portion 125 is a first extending portion extending straight from the bent portion 124 toward the distal end side of the arm portion 103. The straight portion 126 is a second extending portion extending straight from the bent portion 124 to the opposite side to the straight portion 125, that is, toward the proximal end side of the arm portion 103. In other words, the straight portion 125 is disposed closer to the free end than the bent portion 124, and the straight portion 126 is disposed closer to the fixed end than the bent portion 124. The bent portion 124 is a portion bent by the press working described above. To be noted, although a case where the first and second extending portions of the metal member 120 are straight will be described, the first and second extending portions may be curved.

As illustrated in FIG. 6B, the straight portion 125 of the metal member 120 includes a surface 125A serving as a first metal surface and a surface 125B serving as a second metal surface positioned on the opposite side to the surface 125A. The surface 125A is a surface extending from a major angle 124A of the bent portion 124, and the surface 125B is a surface extending from a minor angle 124B of the bent portion 124. The straight portion 126 includes a surface 126A serving as a third metal surface and a surface 126B serving as a fourth metal surface positioned on the opposite side to the surface 126A. The surface 126A is a surface extending from the major angle 124A of the bent portion 124, and the surface 126B is a surface extending from the minor angle 124B of the bent portion 124.

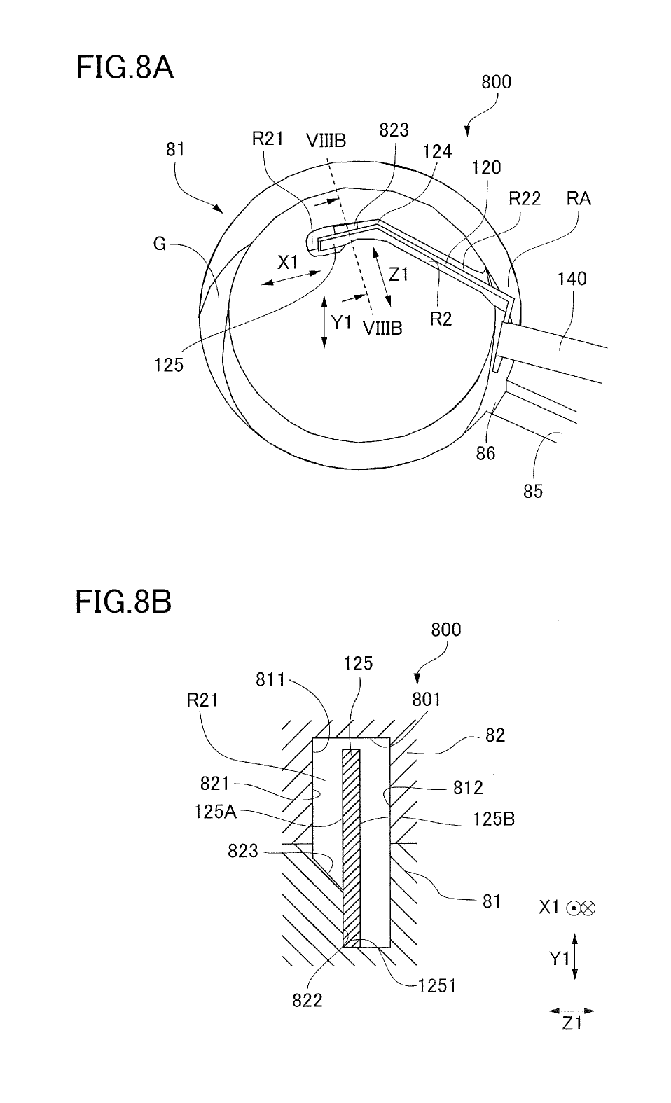

FIG. 8A is a perspective view of the metal member 120 disposed in the cavity RA of the mold 800. FIG. 8B is a section view of the molds 81 and 82 taken along a line VIIIB of FIG. 8A illustrating a state in which the molds 81 and 82 are clamped. To be noted, illustration of the mold 82 among the molds 81 and 82 of the mold 800 is omitted in FIG. 8A. As illustrated in FIGS. 8A and 8B, the direction in which the straight portion 125 extends, that is, the longitudinal direction of the straight portion 125 is defined as an X1 direction. The width direction of the straight portion 125 perpendicular to the X1 direction is defined as a Y1 direction. The thickness direction of the straight portion 125 perpendicular to the X1 direction and the Y1 direction is defined as a Z1 direction.

As illustrated in FIG. 8A, the space R2 is constituted by partial spaces R21 and R22. The partial space R21 is a space for forming the straight portion 105 of the arm portion 103 illustrated in FIGS. 4A and 4B. The partial space R22 is a space for forming the straight portion 106 of the arm portion 103 illustrated in FIGS. 4A and 4B.

FIG. 8B is a section view of a portion defining the partial space R21 in the mold 800. The molds 81 and 82 in a clamped state, that is, the mold 800 includes a wall surface 801 that defines the space R2. The wall surface 801 includes a side wall surface 811 and a side wall surface 812 disposed so as to oppose the side wall surface 811. The side wall surface 811 is a portion forming the surface positioned on the major angle side of the bent portion 104 in the straight portion 105 of the arm portion 103 illustrated in FIGS. 4A and 4B. The side wall surface 812 is a portion forming the surface positioned on the minor angle side of the bent portion 104 in the straight portion 105 of the arm portion 103 illustrated in FIGS. 4A and 4B.

The side wall surface 811 includes a main surface 821, a projecting surface 822, and a tapered surface 823. The projecting surface 822 is a first projecting portion that projects further toward the side wall surface 812 with respect to the main surface 821, and the tapered surface 823 serves as a first tapered surface. The projecting surface 822 and the tapered surface 823 are parts of the side wall surface 811. In the first exemplary embodiment, the projecting surface 822 and the tapered surface 823 are provided on the mold 81 among the molds 81 and 82.

Since the space R2 is a space corresponding to the arm portion 103, the flow path therein for the molten resin M is narrower than in the space R1 corresponding to the trunk portion 101. Therefore, the projecting surface 822 is disposed at such a position as to effectively support the metal member 120 such that the fluidity of the molten resin M in the space R2 is not lowered. That is, the projecting surface 822 is disposed at such a position as to be in contact with a part of the surface 125A of the straight portion 125 of the metal member 120 positioned in the partial space R21 as illustrated in FIG. 8B when the molds 81 and 82 are clamped in the clamping step illustrated in FIG. 7B. Specifically, the projecting surface 822 is disposed at such a position as to be in contact with a part of the surface 125A of the straight portion 125 on an end portion 1251 side in the Y1 direction. The tapered surface 823 is a surface inclined so as to guide the straight portion 125 to the projecting surface 822, and is disposed adjacent to the projecting surface 822.

In the first exemplary embodiment, the metal member 120 is disposed in the groove portion G of the mold 81 before clamping the molds 81 and 82. At this time, the end portion 1251 of the straight portion 125 in the Y1 direction illustrated in FIG. 8B comes into contact with the tapered surface 823, and is guided to a predetermined position in the space R21. Thus, the tapered surface 823 can guide the metal member 120 to a predetermined position, that is, a position at which the metal member 120 comes into contact with the projecting surface 822, when disposing the metal member 120 in the space R2 as illustrated in FIG. 8A. To be noted, the inclination angle of the tapered surface 823 may be determined in consideration of the durability of the mold 81, the rigidity of the metal member 120, the displacement of the metal member 120 in the space R2, and so forth.

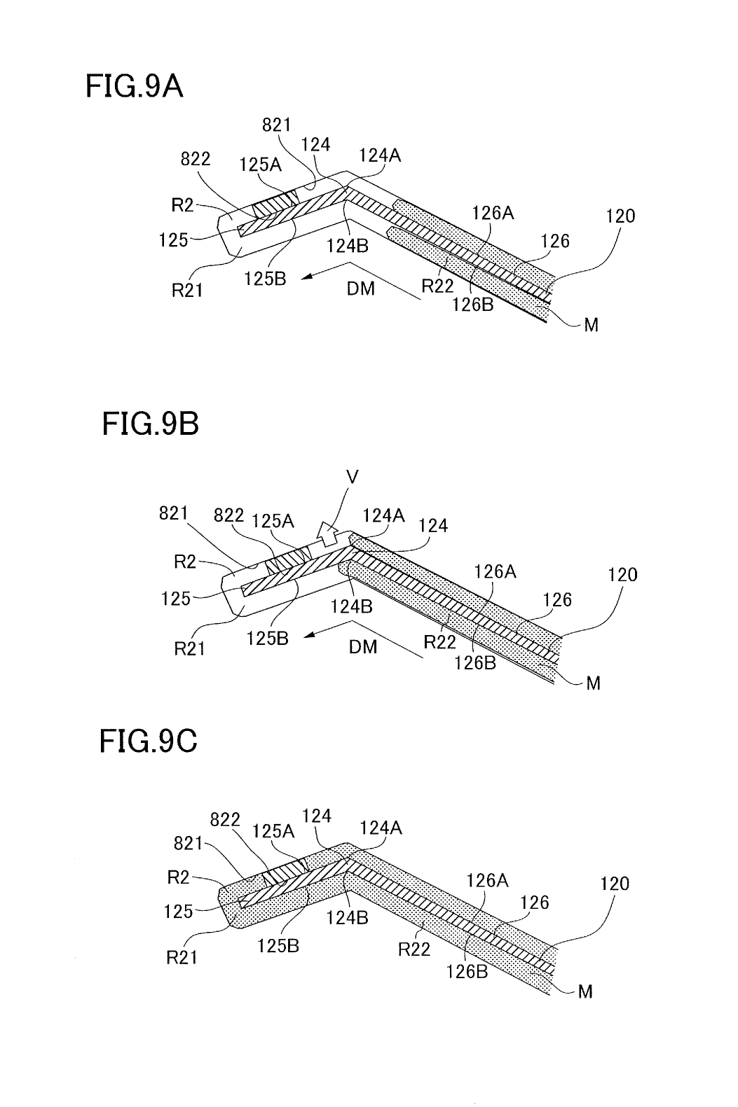

FIGS. 9A, 9B, and 9C are explanatory diagrams illustrating a state in which the molten resin M is injected into the space R2 of the cavity RA illustrated in FIG. 7C. When the molten resin M is supplied to the cavity RA through the gate 86 as illustrated in FIG. 7C, the molten resin M flows to the space R2 through the space R1 as illustrated in FIG. 9A. By clamping the molds 81 and 82 as illustrated in FIG. 7B, the straight portion 126, the bent portion 124, and the straight portion 125 are disposed in the space R2 as illustrated in FIG. 9A. Therefore, the molten resin M flows to the straight portion 126, the bent portion 124, and the straight portion 125 in this order in the space R2. That is, the straight portion 125 is disposed downstream of the bent portion 124 in a flow direction DM of the molten resin M, and the straight portion 126 is disposed upstream of the bent portion 124 in the flow direction DM of the molten resin M.

As illustrated in FIG. 9A, the molten resin M flows along both surfaces 126A and 126B of the straight portion in the flow direction DM. When the molten resin M passes the bent portion 124 as illustrated in FIG. 9B, the molten resin M comes into contact with both surfaces 125A and 125B of the straight portion 125. At this time, since the bent portion 124 is present upstream of the straight portion 125 in the flow direction DM of the molten resin M, the molten resin M abuts the surface 125B of the straight portion 125 disposed on the same side as the minor angle 124B. Therefore, force to deform the metal member 120 is applied to the metal member 120 by the injection pressure of the molten resin M in an arrow V direction of FIG. 9B toward the main surface 821 positioned on the major angle side of the bent portion 124. Although the metal member 120 is provided for reinforcement of the arm portion 103, the metal member 120 cannot support both end portions of the arm portion 103 in the longitudinal direction, and only one side of the metal member 120 is supported by the support member 140 as illustrated in FIG. 6A and so forth.

In the first exemplary embodiment, a part of the surface 125A of the straight portion 125 of the metal member 120 is in contact with and thus supported by the projecting surface 822. According to this, deformation of the metal member 120 caused by the injection pressure of the molten resin M can be suppressed. That is, the straight portion 125 coming into contact with the main surface 821 of the side wall surface 811 can be suppressed as a result of the part of the surface 125A of the straight portion 125 coming into contact with the projecting surface 822.

Then, the molten resin M is injected to the distal end of the space R2 corresponding to the distal end of the arm portion 103 as illustrated in FIG. 9C. To be noted, unillustrated air releasing holes that communicate with the distal end of the space R2 and have such diameters as not to let resin flow therethrough are provided in the molds 81 and 82.

After cooling the molten resin M in the molds 81 and 82, the molded product is taken out of the molds 81 and 82 by the unillustrated ejector pin, and the transmission member 100 illustrated in FIGS. 3, 4A, and 4B is obtained by cutting off resin corresponding to the runner 85 and the support member 140. The arm portion 103 of the transmission member 100 produced by the production method described above includes an exposing portion 111 serving as a first exposing portion that has a shape corresponding to the projecting surface 822 and exposes a part of the surface 125A of the straight portion 125. That is, since the molten resin M solidifies in a state in which the projecting surface 822 is in contact with a part of the surface 125A of the straight portion 125, the portion at which the projecting surface 822 has been in contact with the surface 125A becomes the exposing portion 111 at which the resin member 130 is not present. The exposing portion 111 having the shape corresponding to the projecting surface 822 includes a tapered surface 141 of the resin member 130 corresponding to the tapered surface 823.

As described above, since a part of the surface 125A positioned on the major angle 124A side in the straight portion 125 of the metal member 120 is supported by the projecting surface 822 of the mold 81, deformation of the metal member 120 toward the main surface 821 of the side wall surface 811 can be suppressed. Therefore, deformation of the metal portion 122 of the metal member 120 can be suppressed, thus short shot in the arm portion 103 can be suppressed, and molding failure of the transmission member 100 serving as a molded product can be suppressed. Since deformation of the metal member 120 can be suppressed, generation of restoration force in the metal member 120 after detaching the transmission member 100 from the mold 800 can be suppressed, and deformation of the arm portion 103 by the restoration force of the metal member 120 can be suppressed. Therefore, the production yield of the transmission member 100 is improved.

### Second Exemplary Embodiment

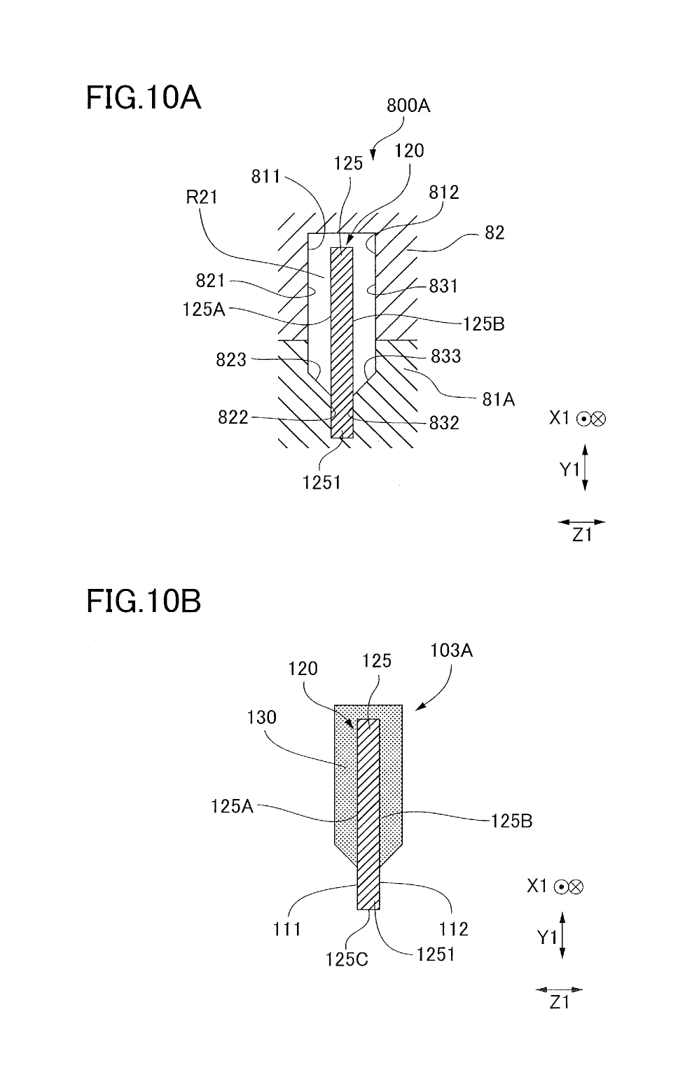

A transmission member serving as an example of a molded product according to a second exemplary embodiment will be described. FIG. 10A is a section view of a space for forming an arm portion in a cavity of a mold for forming the transmission member serving as an example of a molded product according to the second exemplary embodiment. FIG. 10B is a section view of the arm portion of the transmission member according to the second exemplary embodiment.

A mold for insert molding 800A of the second exemplary embodiment includes a mold 81A serving as a first mold and the mold 82 serving as a second mold. In the second exemplary embodiment, the shape of the mold 81A serving as a first mold and the shape of a molded product formed by using the mold 81A are different from the first exemplary embodiment. In the second exemplary embodiment, the side wall surface 812 opposing the side wall surface 811 also includes a projecting surface 832 serving as a second projecting portion that projects further toward the side wall surface 811 with respect to a main surface 831 serving as a second main surface. That is, the mold 81A of the second exemplary embodiment includes two projecting surfaces 822 and 832. The projecting surface 832 is disposed at such a position as to be in contact with a part of the surface 125B of the straight portion 125 of the metal member 120 disposed in the partial space R21.

In the clamping step illustrated in FIG. 7B, the projecting surfaces 822 and 832 come into contact with parts of the surfaces 125A and 125B of the straight portion 125 as illustrated in FIG. 10A, and thus the straight portion 125 is supported by the projecting surfaces 822 and 832. According to this, parts of the surfaces 125A and 125B of the straight portion 125 on the end portion 1251 side in the Y1 direction are nipped and supported by the projecting surfaces 822 and 832. Molten resin is injected into the cavity in the state in which the straight portion 125 is nipped and supported by the projecting surfaces 822 and 832. Since the straight portion 125 is supported by the projecting surfaces 822 and 832, deformation of the metal member 120 caused by the injection pressure of the molten resin can be effectively suppressed.

In the second exemplary embodiment, the side wall surface 812 includes a tapered surface 833 serving as a second tapered surface. The tapered surface 833 is a surface inclined so as to guide the straight portion 125 to the projecting surface 832 and disposed adjacent to the projecting surface 832.

Thus, when disposing the metal member 120 between the molds 81A and 82, that is, on the mold 81A, the end portion 1251 of the straight portion 125 in the Y1 direction is guided to a space defined between the projecting surfaces 822 and 832 by the tapered surface 823 and 833. Therefore, positioning in the Z1 direction is effectively performed by the projecting surfaces 822 and 832. Further, in the injection step illustrated in FIG. 7C, even in the case where the injection pressure of the molten resin is applied to the straight portion 125, deformation and movement of the metal member 120 can be suppressed by the two projecting surfaces 822 and 832. Therefore, molding failure of the transmission member serving as the molded product can be suppressed, and the production yield of the transmission member is improved. To be noted, the clearance between the metal member 120 and the projecting surfaces 822 and 832 is preferably, for example, about 10 μm. The transmission member produced in this manner includes the exposing portion 111 and an exposing portion 112 serving as a second exposing portion that exposes a part of the surface 125B of the straight portion 125 as illustrated in FIG. 10B. The exposing portion 112 is a portion in which the resin member 130 is not present, and has a shape corresponding to the projecting surface 832.

To be noted, although the projecting surfaces 822 and 832, in other words, the exposing portions 111 and 112, may be disposed so as to be displaced from each other in the X1 direction, in the second exemplary embodiment, the projecting surfaces 822 and 832 are disposed at the same positions in the X1 direction, that is, positions opposing in the Z1 direction, in order to effectively support the metal member 120. That is, the projecting surfaces 822 and 832 are disposed to oppose each other such that a part of the end portion 1251 of the straight portion 125 of the metal member 120 in the Y1 direction is interposed therebetween. Further, the exposing portions 111 and 112 are connected to each other at an end surface 125C of the end portion 1251 of the straight portion 125 in the Y1 direction as illustrated in FIG. 10B. That is, a part of the end surface 125C of the end portion 1251 of the straight portion 125 is exposed. According to the configuration described above of the second exemplary embodiment, deformation of the metal member 120 can be effectively suppressed, and the production yield of the transmission member is improved.

### Third Exemplary Embodiment

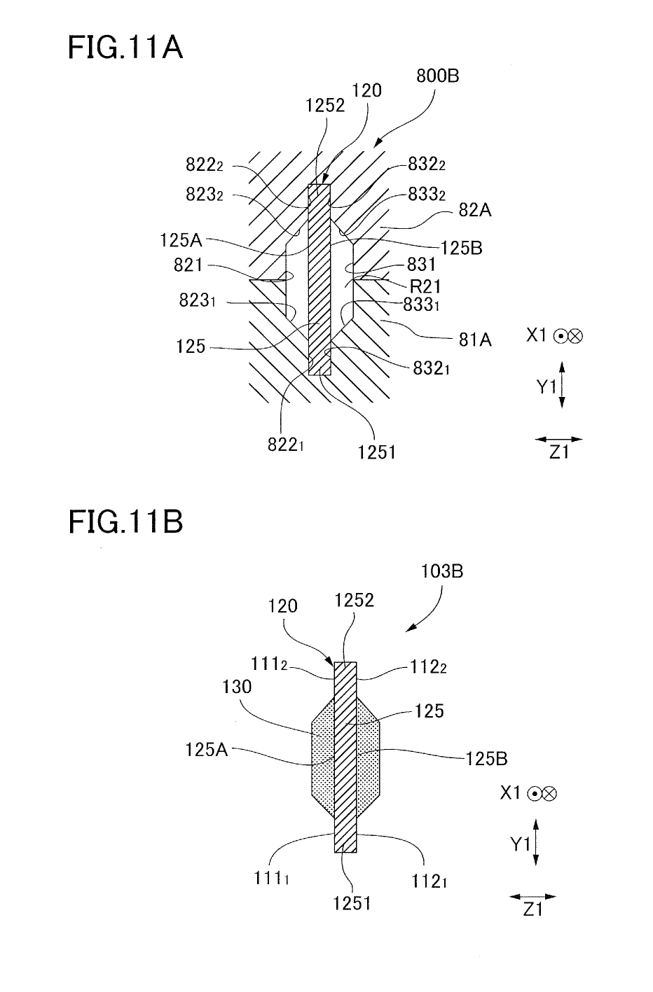

A transmission member serving as an example of a molded product according to a third exemplary embodiment will be described. FIG. 11A is a section view of a space for forming an arm portion in a cavity of a mold for forming the transmission member serving as an example of a molded product according to the third exemplary embodiment. FIG. 11B is a section view of the arm portion of the transmission member according to the third exemplary embodiment.

A mold for insert molding 800B of the third exemplary embodiment includes the fixed mold 81A serving as a first mold and a movable mold 82A serving as a second mold. In the second exemplary embodiment, a case where the pair of projecting surfaces 822 and 832 are applied to the mold 81A has been described. In the third exemplary embodiment, the pair of projecting surfaces 822 and 832 are applied further to the mold 82A as illustrated in FIG. 11A. That is, the molds 81A and 82A each include a pair of projecting surfaces having a similar configuration to the projecting surfaces 822 and 832 of the second exemplary embodiment described above.

Specifically, the mold 81A includes a projecting surface 822₁ serving as a first projecting portion and a projecting surface 832₁ serving as a second projecting portion. The mold 82A includes a projecting surface 822₂ serving as a third projecting portion and a projecting surface 832₂ serving as a fourth projecting portion. The projecting surface 822₂ is disposed at a position different from the position of the projecting surface 822₁ in the Y1 direction and such a position as to support a part of the surface 125A disposed on the major angle side of the bent portion 124. The projecting surface 832₂ is disposed at a position different from the position of the projecting surface 832₁ in the Y1 direction and such a position as to support a part of the surface 125B disposed on the minor angle side of the bent portion 124. The pair of projecting surfaces 822₁ and 832₁ of the mold 81A and the pair of projecting surfaces 822₂ and 832₂ of the mold 82A are disposed at the same position in the X1 direction. Tapered surfaces 823₁, 833₁, 823₂, 833₂ are respectively disposed adjacent to the projecting surfaces 822₁, 832₁, 822₂, and 832₂.

FIG. 11A illustrates a state in which the molds 81A and 82A are clamped in the clamping step illustrated in FIG. 7B. As illustrated in FIG. 11A, both end portions 1251 and 1252 of the straight portion 125 in the Y1 direction are supported by the pair of projecting surfaces 822₁ and 832₁ of the mold 81A and the pair of projecting surfaces 822₂ and 832₂ of the mold 82A. Therefore, in the injection step illustrated in FIG. 7C, the molten resin is injected into the cavity in a state in which the straight portion 125 is supported by the projecting surfaces 822₁, 832₁, 822₂, and 832₂, and thus deformation of the metal member 120 can be effectively suppressed. Since the mold 82A includes the tapered surfaces 823₂ and 833₂ similarly to the mold 81A, the metal member 120 can be more effectively positioned. In an arm portion 103B of the transmission member serving as a molded product produced by using the molds 81A and 82A described above, the pair of exposing portions 111 and 112 are formed in the both end portions 1251 and 1252 of the straight portion 125 in the Y1 direction. As illustrated in FIG. 11B, the arm portion 103B includes an exposing portion 111₁ serving as a first exposing portion and an exposing portion 112₁ serving as a second exposing portion respectively formed by the projecting surfaces 822₁ and 832₁. In addition, the arm portion 103B includes an exposing portion 111₂ serving as a third exposing portion and an exposing portion 112₂ serving as a fourth exposing portion respectively formed by the projecting surfaces 822₂ and 832₂. That is, the exposing portion 111₂ is disposed at a position different from the exposing portion 111₁ in the Y1 direction and such a position as to expose a part of the surface 125A. The exposing portion 112₂ is disposed at a position different from the exposing portion 112₁ in the Y1 direction and such a position as to expose a part of the surface 125B. According to the third exemplary embodiment, deformation of the metal member 120 can be more effectively suppressed, and the production yield of the transmission member is improved.

In the fixed mold 81A, the clearance between the metal member 120 and the projecting surfaces 822₁ and 832₁ is preferably, for example, about 50 μm. In the movable mold 82A, the clearance between the metal member 120 and the projecting surfaces 822₂ and 832₂ is preferably, for example, about 15 μm. With clearances of these values, the function of guiding the metal member 120 in the clamping step and the function of suppressing the deformation of the metal member 120 in the injection step become effective. To be noted, one or both of the projecting surfaces 832 of the molds 81A and 82A may be omitted.

### Fourth Exemplary Embodiment

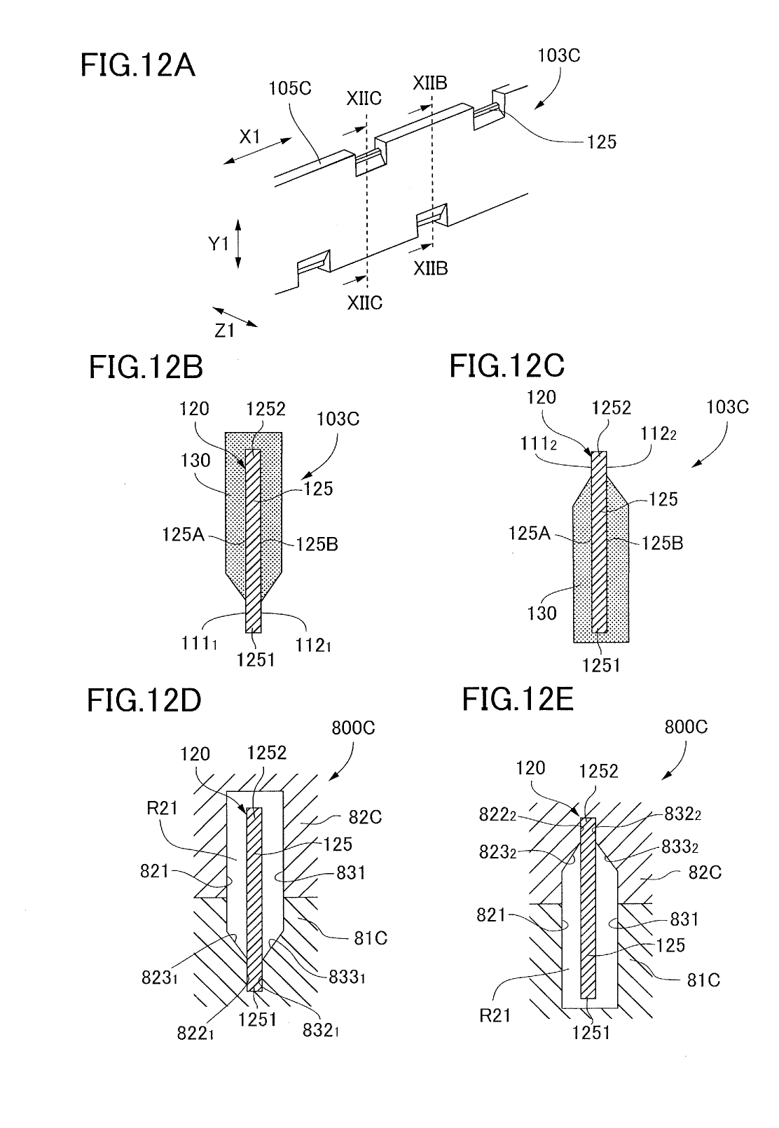

A transmission member serving as an example of a molded product according to a fourth exemplary embodiment will be described. FIG. 12A is a partial perspective view of the transmission member serving as an example of a molded product according to the fourth exemplary embodiment. FIG. 12B is a section view of an arm portion 103C taken along a line XIIB of FIG. 12A, and FIG. 12C is a section view of the arm portion 103C taken along a line XIIC of FIG. 12A.

As illustrated in FIGS. 12A, 12B, and 12C, the pairs of exposing portions 111 and 112 disposed at the both end portions 1251 and 1252 of a straight portion 105C of the arm portion 103C of the transmission member according to the fourth exemplary embodiment in the Y1 direction are disposed to be displaced from each other in the X1 direction. That is, the positions of the pair of exposing portions 111₁ and 112₁ are displaced from the positions of the pair of exposing portions 111₂ and 112₂ in the X1 direction.

FIG. 12D is a section view of a part of molds 81C and 82C corresponding to FIG. 12B. FIG. 12E is a section view of a part of the molds 81C and 82C corresponding to FIG. 12C. A mold for insert molding 800C of the fourth exemplary embodiment includes the fixed mold 81C serving as a first mold and the movable mold 82C serving as a second mold. FIGS. 12D and 12E illustrate a state in which the molds 81C and 82C are clamped. When the molds 81C and 82C are clamped, the pair of projecting surfaces 822₁ and 832₁ of the mold 81C illustrated in FIG. 12D and the pair of projecting surfaces 822₂ and 832₂ of the mold 82C illustrated in FIG. 12E are disposed to be displaced from each other in the X1 direction in the space R21. That is, the pair of projecting surfaces 822₁ and 832₁ of the mold 81C and the pair of projecting surfaces 822₂ and 832₂ of the mold 82C illustrated in FIG. 12E are arranged in a staggered manner in the X1 direction. In this way, since the pair of projecting surfaces 822₁ and 832₁ and the pair of projecting surfaces 822₂ and 832₂ are arranged in a staggered manner in the flow direction of the molten resin, deformation of the metal member 120 caused by the injection pressure of the molten resin can be suppressed while ensuring the width of the flow path of the molten resin.

To be noted, the number and dimensions of the pair of projecting surfaces 822₁ and 832₁ of the mold 81C and the pair of projecting surfaces 822₂ and 832₂ of the mold 82C can be arbitrarily set.

### Fifth Exemplary Embodiment

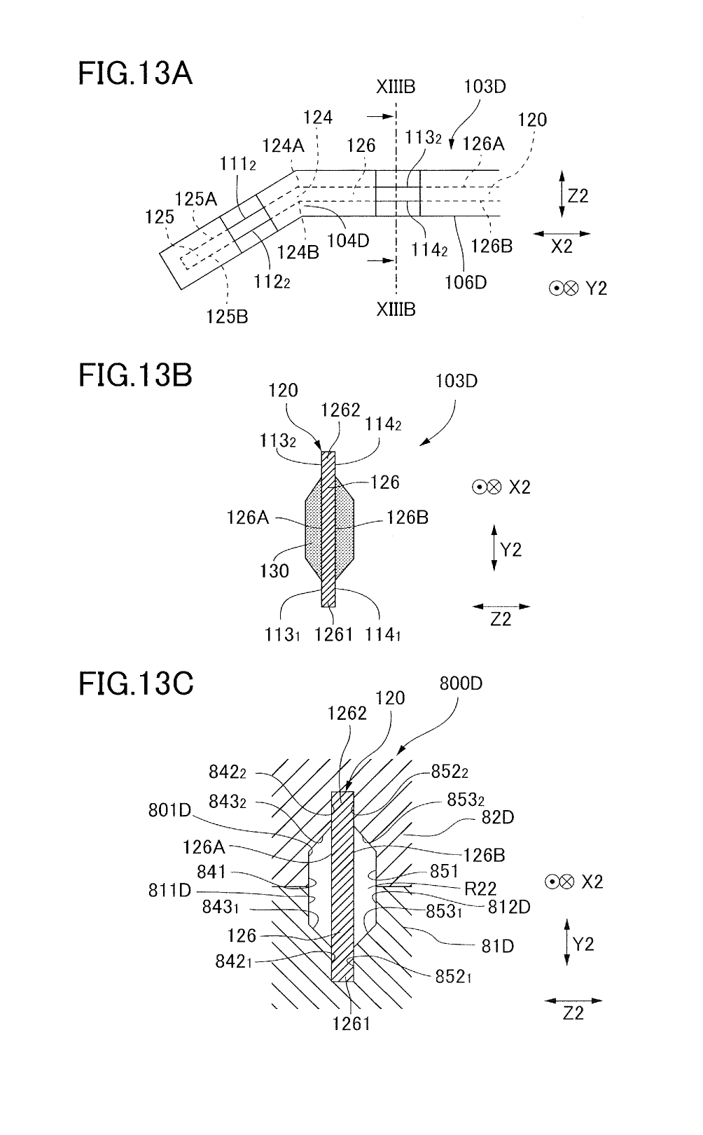

A transmission member serving as an example of a molded product according to a fifth exemplary embodiment will be described. FIG. 13A is a plan view of an arm portion of the transmission member serving as an example of a molded product according to the fifth exemplary embodiment. FIG. 13B is a section view of an arm portion 103D taken along a line XIIIB of FIG. 13A. FIG. 13C is a section view of a part of molds 81D and 82D corresponding to FIG. 13B.

To be noted, a direction in which the straight portion 126 of the metal member 120, that is, the longitudinal direction of the straight portion 126 is defined as an X2 direction. The width direction of the straight portion 126 perpendicular to the X2 direction is defined as a Y2 direction. The thickness direction of the straight portion 126 perpendicular to the X2 direction and the Y2 direction is defined as a Z2 direction.

The molds 81D and 82D in a clamped state, that is, the mold 800D includes a wall surface 801D that defines the space R2. The wall surface 801D includes a side wall surface 811D and a side wall surface 812D disposed so as to oppose the side wall surface 811D. The side wall surface 811D is a portion forming the surface positioned on the major angle side of a bent portion 104D in a straight portion 106D of the arm portion 103D. The side wall surface 812D is a portion forming the surface positioned on the minor angle side of the bent portion 104D in the straight portion 106D of the arm portion 103D.

The side wall surface 811D of the mold 81D includes a main surface 841, a projecting surface 842₁, and a tapered surface 843₁. The main surface 841 serves as a third main surface. The projecting surface 842₁ serves as a fifth projecting portion projecting further toward the side wall surface 812D with respect to the main surface 841. The tapered surface 843₁ serves as a fifth tapered surface. The projecting surface 842₁ and the tapered surface 843₁ are parts of the side wall surface 811D.

The projecting surface 842₁ is disposed at such a position as to be in contact with a part of the surface 126A of the straight portion 126 of the metal member 120 disposed in the partial space R22 as illustrated in FIG. 13C when the molds 81D and 82D are clamped in the clamping step illustrated in FIG. 7B. Specifically, the projecting surface 842₁ is disposed at such a position as to be in contact with a part of the surface 126A of the straight portion 126 in an end portion 1261 in the Y2 direction. The tapered surface 843₁ is a surface inclined so as to guide the straight portion 126 to the projecting surface 842₁ and is disposed adjacent to the projecting surface 842₁.

The side wall surface 812D of the mold 81D includes a main surface 851, a projecting surface 852₁, and a tapered surface 853₁. The main surface 851 serves as a fourth main surface. The projecting surface 852₁ serves as a sixth projecting portion projecting further toward the side wall surface 811D with respect to the main surface 851. The tapered surface 853₁ serves as a sixth tapered surface. The projecting surface 852₁ and the tapered surface 853₁ are parts of the side wall surface 812D.

The projecting surface 852₁ is disposed at such a position as to be in contact with a part of the surface 126B of the straight portion 126 of the metal member 120 disposed in the partial space R22 as illustrated in FIG. 13C when the molds 81D and 82D are clamped in the clamping step illustrated in FIG. 7B. Specifically, the projecting surface 852₁ is disposed at such a position as to be in contact with a part of the surface 126B of the straight portion 126 in the end portion 1261 in the Y2 direction. The tapered surface 853₁ is a surface inclined so as to guide the straight portion 126 to the projecting surface 852₁ and is disposed adjacent to the projecting surface 852₁.

According to the configuration described above, the straight portion 126 is supported by the projecting surfaces 842₁ and 852₁ on parts of the surfaces 126A and 126B of the straight portion in the end portion 1261 in the Y2 direction in the clamping step illustrated in FIG. 7B, and thus deformation of the metal member 120 can be more effectively suppressed.

When disposing the metal member 120 between the molds 81D and 82D, the end portion 1261 of the straight portion 126 in the Y2 direction is guided to a space interposed between the projecting surfaces 842₁ and 852₁ by the tapered surfaces 843₁ and 853₁. Therefore, positioning in the Z2 direction is effectively performed by the projecting surfaces 842₁ and 852₁. Further, in the injection step illustrated in FIG. 7C, even when the injection pressure of the molten resin is applied to the straight portion 125, deformation and movement of the metal member 120 can be suppressed by the two projecting surfaces 842₁ and 852₁. Since the metal member 120 is supported on both of the upstream side and downstream side of the bent portion 124 in the flow direction of the molten resin, warpage of the arm portion 103D of the transmission member serving as a molded product can be more effectively suppressed. Therefore, molding failure of the transmission member serving as the molded product can be suppressed, and the production yield of the transmission member is improved.

The transmission member produced as described above includes an exposing portion 113₁ serving as a fifth exposing portion and an exposing portion 114₁ serving as a sixth exposing portion as illustrated in FIG. 13B. The exposing portion 113₁ exposes a part of the surface 126A of the straight portion 126. The exposing portions 113₁ and 114₁ are portions at which the resin member 130 are not present and have shapes corresponding to the projecting surfaces 842₁ and 852₁.

To be noted, although the projecting surfaces 842₁ and 852₁, in other words, the exposing portions 113₁ and 114₁, may be disposed so as to be displaced from each other in the X2 direction, in the fifth exemplary embodiment, the projecting surfaces 842₁ and 852₁ are disposed at the same positions in the X2 direction in order to effectively support the metal member 120. That is, the projecting surfaces 842₁ and 852₁ are disposed to oppose each other such that a part of the end portion 1261 of the straight portion 126 of the metal member 120 in the Y2 direction is interposed therebetween. Further, the exposing portions 113₁ and 114₁ are connected to each other at the end portion 1261 of the arm portion 103D in the Y2 direction as illustrated in FIG. 13B. Thus, the exposing portions 113₁ and 114₁ are connected to each other at the end portion 1261 of the straight portion 126 in the Y2 direction. According to the configuration described above of the fifth exemplary embodiment, deformation of the metal member 120 can be effectively suppressed, and the production yield of the transmission member is improved.

In the fifth exemplary embodiment, a pair of a projecting surface 842₂ serving as a seventh projecting portion and a projecting surface 852₂ serving as an eighth projecting portion are further applied to the movable mold 82D similarly to the mold 81D as illustrated in FIG. 13C. The projecting surface 842₂ is disposed at a position different from the position of the projecting surface 842₁ in the Y2 direction and such a position as to support a part of the surface 126A. The projecting surface 852₂ is disposed at a position different from the position of the projecting surface 852₁ in the Y2 direction and such a position as to support a part of the surface 126B. The pair of projecting surfaces 842₁ and 852₁ of the mold 81D and the pair of projecting surfaces 842₂ and 852₂ of the mold 82D are disposed at the same positions in the X2 direction. To be noted, also in the fifth exemplary embodiment, tapered surfaces 843₂ and 853₂ are respectively disposed adjacent to the projecting surfaces 842₂ and 852₂. Therefore, the metal member 120 can be more effectively positioned.

As illustrated in FIG. 13C, the both end portions 1261 and 1262 of the straight portion 126 in the Y2 direction are supported by the pair of projecting surfaces 842₁ and 852₁ of the mold 81D and the pair of projecting surfaces 842₂ and 852₂ of the mold 82D. Therefore, in the injection step illustrated in FIG. 7C, deformation of the metal member 120 can be effectively suppressed. In the arm portion 103D of the transmission member serving as a molded product produced by using the molds 81D and 82D described above, the pair of exposing portions 113₁ and 114₁ and a pair of exposing portions 113₂ and 114₂ are respectively disposed in the both end portions 1261 and 1262 of the straight portion 126 in the Y2 direction as illustrated in FIG. 13B. That is, the arm portion 103D includes the exposing portion 113₂ serving as a seventh exposing portion and the exposing portion 114₂ serving as an eighth exposing portion. The exposing portion 113₂ is disposed at a position different from the exposing portion 113₁ in the Y2 direction and such a position as to expose a part of the surface 126A. The exposing portion 114₂ is disposed at a position different from the exposing portion 114₁ in the Y2 direction and such a position as to expose a part of the surface 126B. According to the fifth exemplary embodiment described above, deformation of the metal member 120 can be effectively suppressed, and the production yield of the transmission member is improved.

To be noted, as described in the fifth exemplary embodiment, although a case where each of the molds 81D and 82D includes a pair of projecting surfaces 842 and 852 is preferable, the pair of projecting surfaces 842 and 852 may be omitted from either one of the molds 81D and 82D. The projecting surface 852 may be omitted from the mold 81D or the mold 82D.

The pair of exposing portions 113₁ and 114₁ and the pair of exposing portions 113₂ and 114₂ disposed at end portions of the arm portion 103D in the Y2 direction may be disposed to be displaced from each other in the X2 direction as in the fourth exemplary embodiment. In this case, as in the fourth exemplary embodiment, it suffices if the pair of projecting surfaces 842₁ and 852₁ of the mold 81D and the pair of projecting surfaces 842₂ and 852₂ of the mold 82D are displaced from each other in the X2 direction when the molds 81D and 82D are clamped. According to this, deformation of the metal member 120 caused by the injection pressure of the molten resin can be suppressed while ensuring the width of the flow path of the molten resin.

### Sixth Exemplary Embodiment

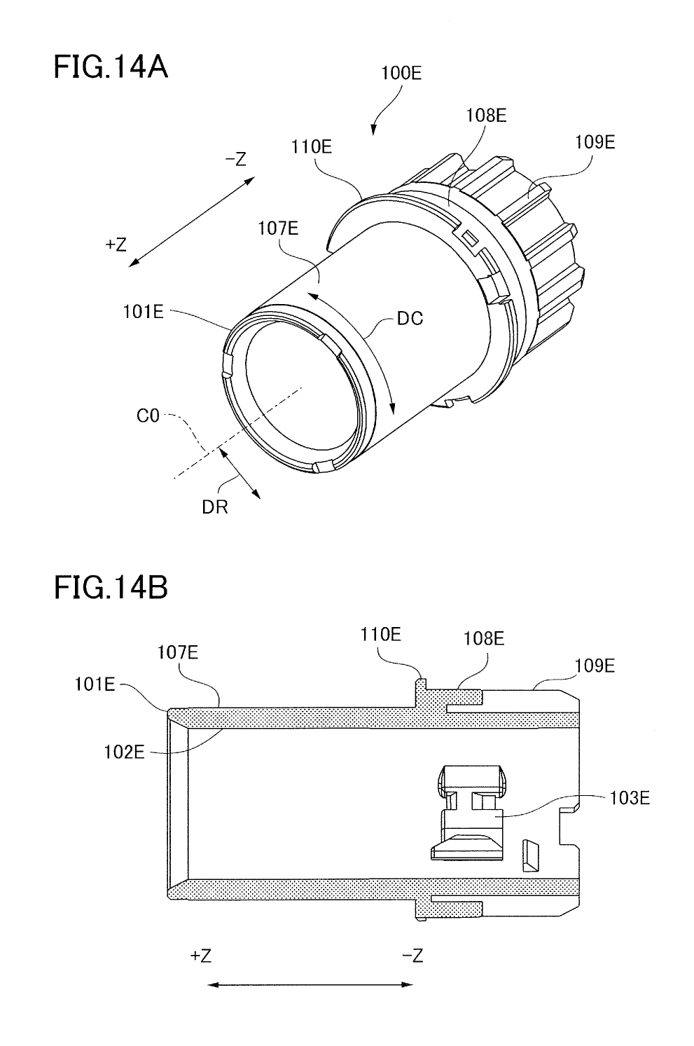

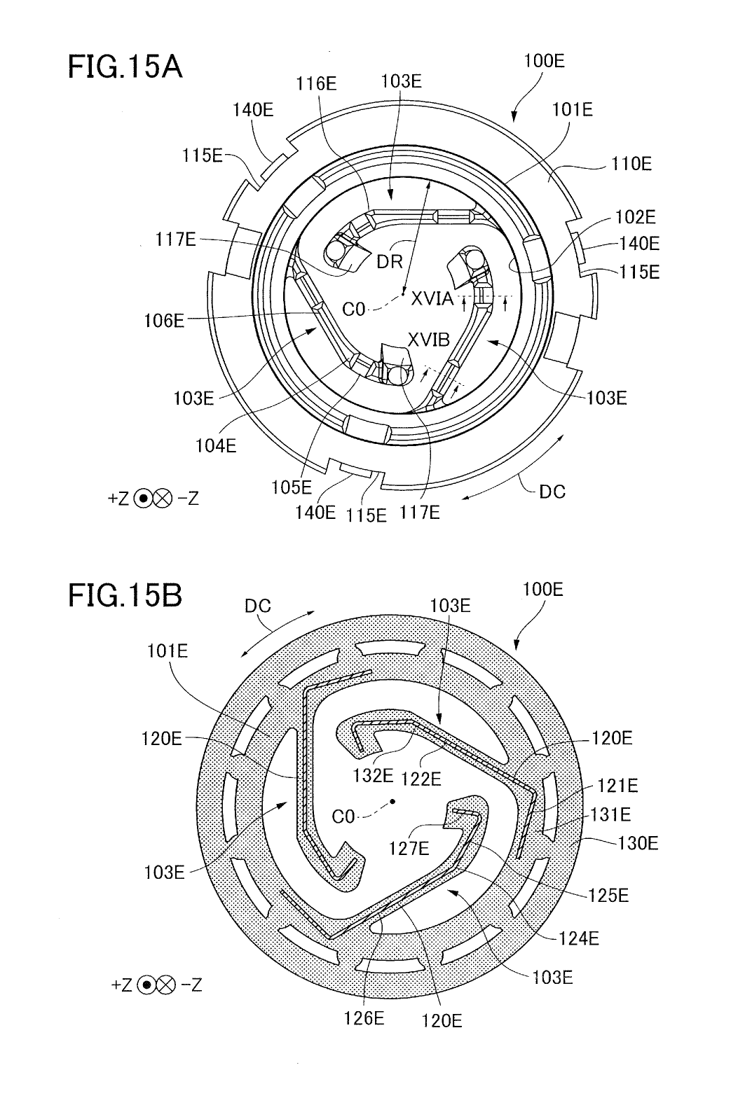

A transmission member serving as an example of a molded product according to a sixth exemplary embodiment will be described. FIG. 14A is a perspective view of a transmission member 100E serving as an example of a molded product according to the sixth exemplary embodiment. FIG. 14B is a section view of the transmission member 100E taken along a direction of an axis C0 perpendicular to a radial direction DR of the transmission member 100E. FIG. 15A is a plan view of the transmission member 100E viewed in the −Z direction, and FIG. 15B is a section view of the transmission member 100E taken along the radial direction DR of the transmission member 100E. The transmission member 100E is disposed in an end portion of the photosensitive drum 21 of the cartridge 20 illustrated in FIG. 2 in the longitudinal direction, that is, the ±Z direction, similarly to the first to fifth exemplary embodiments. The transmission member 100E is produced by insert molding similarly to the first to fifth exemplary embodiments. To be noted, the production method of the molded product using a mold is the same as the first to fifth exemplary embodiments, and descriptions of the production method and the mold will be omitted.

The transmission member 100E includes a cylindrical trunk portion 101E as illustrated in FIGS. 14A and 14B. To be noted, the axis C0 illustrated in FIG. 14A is an axis passing through the center of the cylindrical trunk portion 101E. The transmission member 100E includes a plurality of arm portions 103E extending from an inner circumferential surface 102E of the trunk portion 101E as illustrated in FIGS. 15A and 15B. In the sixth exemplary embodiment, the transmission member 100E includes three arm portions 103E. The three arm portions 103E are arranged in a circumferential direction DC at equal intervals.

A press-fitting portion 108E and a guide portion 109 are provided on an outer circumferential surface 107E of the trunk portion 101E as illustrated in FIGS. 14A and 14B. The press-fitting portion 108E is press-fit on the inner circumferential surface of the photosensitive drum 21, and the guide portion 109E guides the inner circumferential surface of the photosensitive drum 21 to the press-fitting portion 108E. The guide portion 109E is disposed on the −Z direction side with respect to the press-fitting portion 108E.

The press-fitting portion 108E is press-fit inside the photosensitive drum 21, and thus an unillustrated coupling member is fixed to the photosensitive drum 21. Specifically, the inner circumferential surface of the photosensitive drum 21 and the outer circumferential surface of the press-fitting portion 108E have such dimensions that the two are in a relationship of tight fit. To be noted, the dimensions do not have to be in the relationship of tight fit in the case of a configuration in which the tightness of the fit is improved by additional tightening or in the case of fixing the inner circumferential surface of the photosensitive drum 21 to the outer circumferential surface of the press-fitting portion 108E by gluing.

A brim portion 110E that functions as a stopper when press-fitting the press-fitting portion 108E in the photosensitive drum 21 is provided on the outer circumferential surface 107E of the trunk portion 101E. The brim portion 110E is disposed on the +Z direction side with respect to the press-fitting portion 108E. To be noted, in the production process of the transmission member 100E, metal members 120E are supported by support members 140 illustrated in FIG. 6 similarly to the first exemplary embodiment. Further, although the metal members 120E and the support members 140 are cut apart along the broken line L illustrated in FIG. 6 by the cutting machine 90 illustrated in FIG. 5 in a step after the injection molding, end portions 140E of the metal members 120E may project from the outer circumferential surface 107E of the trunk portion 101E. The end portions 140E of the metal members 120E may be disposed in the brim portion 110E, and, as illustrated in FIG. 15A, the end portions 140E are preferably disposed in recess portions 115E provided in the brim portion 110E. In FIG. 15A, the end portions 140E of the metal members 120E are respectively exposed at three recess portions 115E in correspondence with the three arm portions 103E. According to this, the end portions 140E can be disposed inside the outer circumference of the brim portion 110E, that is, a circle formed by connecting outer edges of parts of the brim portion 110E where the recess portions 115E are not provided, when the brim portion 110E is viewed from above the sheet surface of FIG. 15A. By disposing the end portions 140E inside the outer circumference, a person touching the end portions 140E can be suppressed.

The arm portions 103E each include an arm body 116E, and a craw portion 117E provided at the distal end of the arm body 116E. The arm body 116E extends from the inner circumferential surface 102E of the trunk portion 101E. The craw portion 117E can be moved in the radial direction DR by elastically deforming the arm body 116E in the radial direction DR.

The arm body 116E includes a straight portion 106E, a bent portion 104E, and a straight portion 105E in this order from the proximal end side, at which the arm body 116E is connected to the trunk portion 101E, toward the distal end side similarly to the first exemplary embodiment. The straight portion 105E is provided with the craw portion 117E.

In the sixth exemplary embodiment, the metal members 120E are each disposed so as to be present in the trunk portion 101E, the straight portion 106E, the bent portion 104E, the straight portion 105E, and the craw portion 117E. The metal members 120E are integrally provided with a resin member 130E. Here, the metal member 120E are each constituted by a metal portion 121E and a metal portion 122E extending from the metal portion 121E. The metal portion 121E is a constituent of the trunk portion 101E and serves as a first metal portion. The metal portion 122E is a constituent of the arm portion 103E and serves as a second metal portion. The resin member 130E is a constituent of the trunk portion 101E, and is constituted by resin portions 131E and 132E. The resin portion 131E serves as a first resin portion that is a constituent of the trunk portion 101E and is integrally provided with the metal portion 121E. The resin portion 132E serves as a second resin portion that is a constituent of the arm portion 103E and is integrally provided with the metal portion 122E.

The metal members 120E, specifically, the metal portions 122E, serving as insert members each have a shape following the arm portion 103E and includes a straight portion 126E, a bent portion 124E, and a straight portion 125E similarly to the first exemplary embodiment. The straight portion 125E is a first extending portion that extends straight from the bent portion 124E toward the distal end of the arm portion 103E. The straight portion 126E is a second extending portion that extends straight from the bent portion 124E in a direction opposite to the straight portion 125E, that is, toward the proximal end of the arm portion 103E. A hook portion 127E corresponding to the claw portion 117E is provided on the distal end side of the straight portion 126E. To be noted, the hook portion 127E is provided with an unillustrated through hole in order to improve the adhesion between the resin member 130E and the metal member 120E.

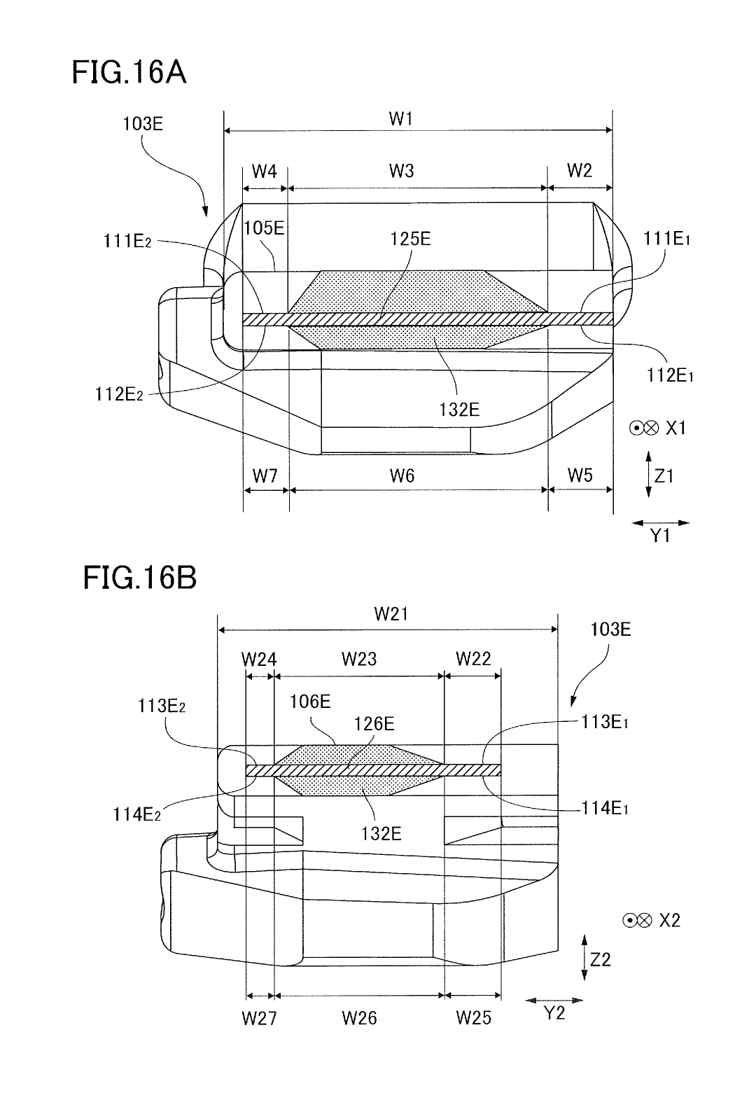

FIG. 16A is a section view of the arm portion 103E taken along a line XVIA of FIG. 15A, and FIG. 16B is a section view of the arm portion 103E taken along a line XVIB of FIG. 15A. As illustrated in FIG. 16A, the straight portion 125E includes a pair of exposing portions 111E₁ and 112E₁ similarly to the pair of exposing portions 111₁ and 112₁ of the fifth exemplary embodiment, and a pair of exposing portions 111E₂ and 112E₂ similarly to the pair of exposing portions 111₂ and 112₂ of the fifth exemplary embodiment. As illustrated in FIG. 16B, the straight portion 126E includes a pair of exposing portions 113E₁ and 114E₁ similarly to the pair of exposing portions 113₁ and 114₁ of the fifth exemplary embodiment, and a pair of exposing portions 113E₁ and 114E₂ similarly to the pair of exposing portions 113₂ and 114₂ of the fifth exemplary embodiment.

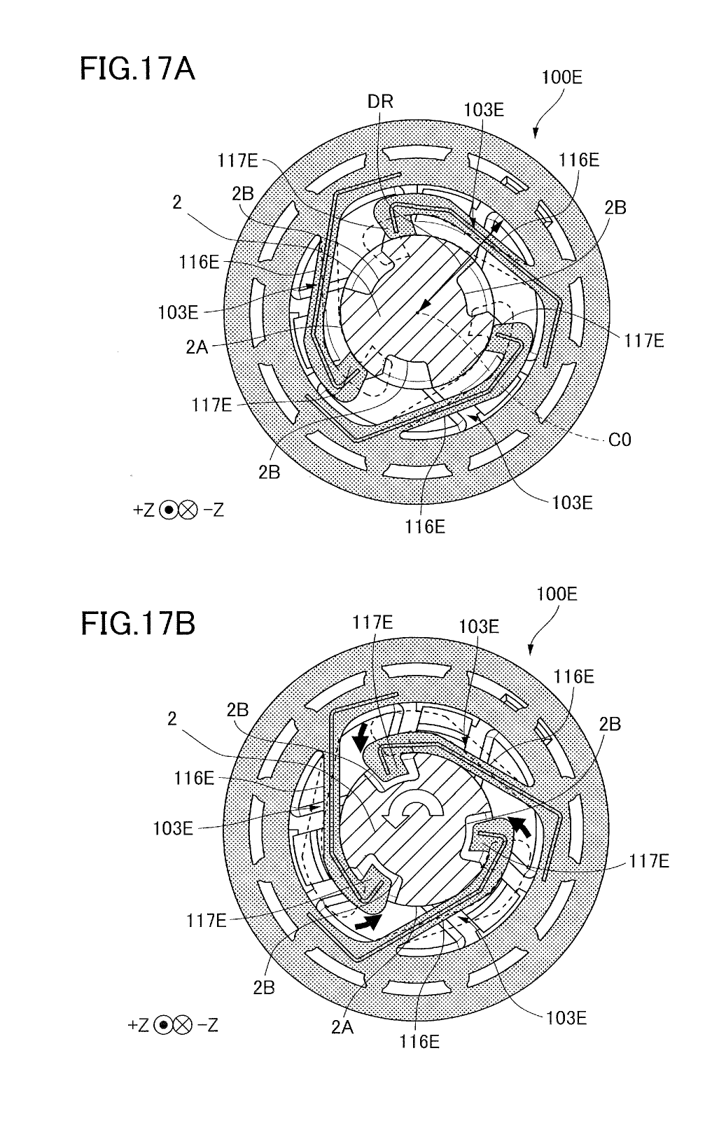

FIGS. 17A and 17B are explanatory diagrams for attachment of the transmission member 100E to the drive shaft 2. An outer circumferential surface 2A of the drive shaft 2 is provided with three groove portions 2B disposed in correspondence with the claw portions 117E. Each groove portion 2B extends in the ±Z direction. The claw portions 117E of the arm portions 103E are respectively formed in shapes that fit in the respective groove portions 2B of the drive shaft 2, and receive rotational force from the drive shaft 2 by engaging with the groove portions 2B, that is, fitting in the groove portions 2B.

At the time of attaching the cartridge 20 illustrated in FIG. 2 to the image forming apparatus body 1, a user disposes the cartridge 20 such that the drive shaft 2 and the transmission member 100E illustrated in FIG. 17A are coaxial, and then moves the cartridge 20 in the +Z direction. As a result of this, as illustrated in FIG. 17A, the arm bodies 116E of the arm portions 103E are elastically deformed toward the outside in the radial direction DR, and the claw portions 117E come into contact with the outer circumferential surface 2A of the drive shaft 2. In the case where the drive shaft 2 rotates in this state, the elastically deformed arm bodies 116E restore toward the inside in the radial direction DR and the claw portions 117E are fit in the groove portions 2B when the groove portions 2B oppose the claw portion 117E as illustrated in FIG. 17B. To be noted, at the time of detaching the cartridge 20 from the image forming apparatus body 1, the user moves the cartridge 20 in the −Z direction, and thus the transmission member 100E moves in the −Z direction. As a result of this, the arm bodies 116E of the arm portions 103E are elastically deformed toward the outside in the radial direction DR, and the claw portions 117E are disengaged from the groove portions 2B.

As described above, according to the transmission member 100E of the sixth exemplary embodiment, since the metal members 120E and the resin member 130E are integrally provided, the rigidity and creep strength of the arm portions 103E of the transmission member 100E can be improved.

Next, the dimensions of the exposing portions will be described with reference to FIGS. 16A and 16B. Here, the thickness dimensions of the metal member 120E in the Z1 and Z2 directions are set to 0.2 mm, and the width dimensions thereof in the Y1 and Y2 directions are set to 4.3 mm. The dimension of the straight portion 105E of the arm portion 103E in the Z1 direction is set to 1.2 mm, and the dimension of the straight portion 106E of the arm portion 103E in the Z2 direction is set to 0.9 mm. The dimension of each of the exposing portions 111E and 112E in the X1 direction is set to 1.0 mm, and the dimension of each of the exposing portions 113E and 114E in the X2 direction is set to 2.0 mm. The metal member 120E formed from a stainless steel plate, and the resin member 130E is formed from POM. Stainless steel will be also referred to as SUS. LC750 manufactured by Asahi Kasei Chemicals Corporation is used as the POM.

In FIG. 16A, the dimension of the straight portion 105E of the arm portion 103E in the Y1 direction is set to W1. The dimension in the Y1 direction of the exposing portion 111E₁ on the major angle side is set to W2. The dimension in the Y1 direction of the resin portion 132E on the major angle side is set to W3. The dimension in the Y1 direction of the exposing portion 111E₂ on the major angle side is set to W4. The dimension in the Y1 direction of the exposing portion 112E₁ on the minor angle side is set to W5. The dimension in the Y1 direction of the resin portion 132E on the minor angle side is set to W6. The dimension in the Y1 direction of the exposing portion 112E₂ on the minor angle side is set to W7. Results of experiments show that, in the case where the ratio (W2+W4)/W1 of the dimension (W2+W4) to the dimension W1 is 80% or smaller, short shot or the like does not occur, and thus the injectability of the molten resin is good. Similarly, in the case where the ratio (W5+W7)/W1 of the dimension (W5+W7) to the dimension W1 is 80% or smaller, short shot or the like does not occur, and thus the injectability of the molten resin is good. To be noted, the dimension W1 is set to 6 mm.

In FIG. 16B, the dimension in the Y2 direction of the straight portion 106E of the arm portion 103E is set to W21. The dimension in the Y2 direction of the exposing portion 113E₁ on the major angle side is set to W22. The dimension in the Y2 direction of the resin portion 132E on the major angle side is set to W23. The dimension in the Y2 direction of the exposing portion 113E₂ on the major angle side is set to W24. The dimension in the Y2 direction of the exposing portion 114E₁ on the minor angle side is set to W25. The dimension in the Y2 direction of the resin portion 132E on the minor angle side is set to W26. The dimension in the Y2 direction of the exposing portion 114E₂ on the minor angle side is set to W27. Results of experiments show that, in the case where the ratio (W22+W24)/W21 of the dimension (W22+W24) to the dimension W21 is 80% or smaller, short shot or the like does not occur, and thus the injectability of the molten resin is good. Similarly, in the case where the ratio (W25+W27)/W21 of the dimension (W25+W27) to the dimension W21 is 80% or smaller, short shot or the like does not occur, and thus the injectability of the molten resin is good. To be noted, the dimension W21 is set to 6 mm.

To be noted, in either case, the ratio being 0% indicates absence of the exposing portion. Therefore, it is required that the ratio is larger than 0%. One of the dimensions W2 and W4 may be 0, and one or both of the dimensions W5 and W7 may be 0. Similarly, one of the dimensions W22 and W24 may be 0, and one or both of the dimensions W25 and W27 may be 0.

### Seventh Exemplary Embodiment

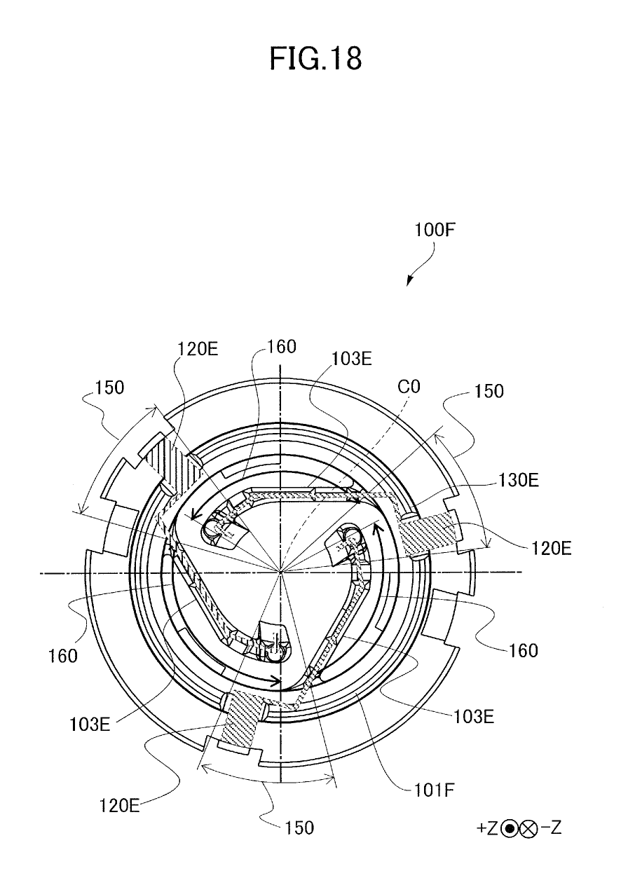

A transmission member serving as an example of a molded product according to the seventh exemplary embodiment will be described. FIG. 18 is a diagram in which parts of the metal members 120E embedded in resin in a transmission member 100F serving as a molded product according to the seventh exemplary embodiment are indicated by broken lines. The seventh exemplary embodiment relates to arrangement of gate traces suitable for improving the creep strength of the arm portions 103E and peeling strength of resin in the case where the transmission member 100F illustrated in FIG. 18 is attached to the drive shaft 2 illustrated in FIGS. 17A and 17B. Although the rigidity and creep strength of the transmission 100F is improved by inserting the metal members 120E, the metal members 120E and the resin member 130E are not connected to each other at the interface thereof. Therefore, according to the transmission member 100F of the seventh exemplary embodiment, peeling of resin from the interface caused by receiving bending stress at the time of attachment to the drive shaft 2 or of transmitting driving force is suppressed.

An inserted metal member 120E is divided into a metal portion 150 embedded in a trunk portion 101F and a metal portion 160 embedded in the arm portion 103E. The metal portion 150 serves as a first metal portion, and the metal portion 160 serves as a second metal portion. At the time of attaching the transmission member 100F to the drive shaft 2 illustrated in FIG. 17 or receiving driving force from the drive shaft 2, bending stress is concentrated in the vicinity of the proximal end of the arm portion 103E. Therefore, if a resin meeting portion, that is, a weld line, formed at the time of injection of the molten resin is present at the metal portion 150, breakage occurs starting from the weld line having a low peeling strength at the time of attaching the transmission member 100F to the drive shaft 2 illustrated in FIG. 17 or at the time of transmission of drive.

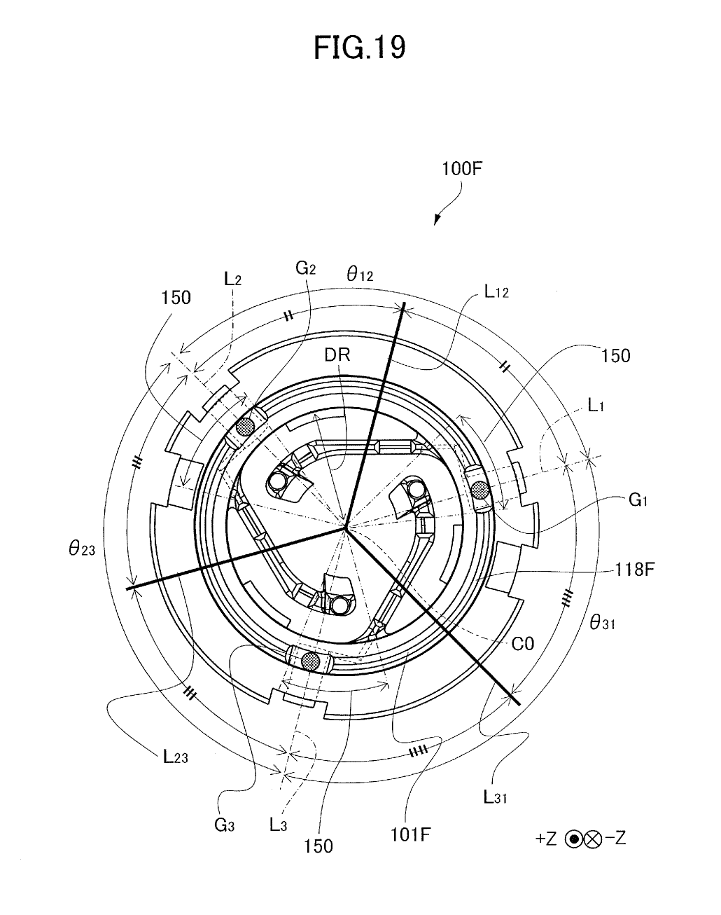

Therefore, the transmission member 100F of the seventh exemplary embodiment is configured so as to improve the peeling strength. The specific configuration of the transmission member 100F will be described below. FIG. 19 is a diagram illustrating positions of gate traces G₁, G₂, and G₃ of the transmission member 100F serving as an example of a molded product according to the seventh exemplary embodiment. The arrangement of the gate traces G₁, G₂, and G₃ will be described below with reference to FIG. 19. A plurality of gate traces G₁, G₂, and G₃ are arranged on an end portion 118F of the trunk portion 101F. The gate traces G₁, G₂, and G₃ are traces of gates for flowing the molten resin into the cavity in the mold. In the seventh exemplary embodiment, three gate traces G₁, G₂, and G₃ are arranged on the end portion 118F of the trunk portion 101F. The gate traces G₁, G₂, and G₃ are arranged in the circumferential direction of the trunk portion 101F at approximately equal intervals. Two gate traces G₁ and G₂ are adjacent to each other, two gate traces G₂ and G₃ are adjacent to each other, and two gate traces G₃ and G₁ are adjacent to each other. Viewing the end portion 118F of the trunk portion 101F in a direction in which the axis C0 extends, that is, the −Z direction, a virtual straight line extending from the axis C0 in the radial direction DR and passing through the gate trace G₁ is set as a straight line L₁. Viewing the end portion 118F of the trunk portion 101F in the −Z direction, a virtual straight line extending from the axis C0 in the radial direction DR and passing through the gate trace G₂ is set as a straight line L₂. Viewing the end portion 118F of the trunk portion 101F in the −Z direction, a virtual straight line extending from the axis C0 in the radial direction DR and passing through the gate trace G₃ is set as a straight line L₃. A virtual straight line bisecting an angle θ₁₂ formed by the straight lines L₁ and L₂ is set as a straight line L₁₂. A virtual straight line bisecting an angle θ₂₃ formed by the straight lines L₂ and L₃ is set as a straight line L₂₃. A virtual straight line bisecting an angle θ₃₁ formed by the straight lines L₃ and L₁ is set as a straight line L₃₁. In the case where a first gate trace is the gate trace G₁ and a second gate trace is the gate trace G₂, a first straight line is the straight line L₁, a second straight line is the straight line L₂, and a third straight line is the straight line L₁₂. In the case where the first gate trace is the gate trace G₂ and the second gate trace is the gate trace G₃, the first straight line is the straight line L₂, the second straight line is the straight line L₃, and the third straight line is the straight line L₂₃. In the case where the first gate trace is the gate trace G₃ and the second gate trace is the gate trace G₁, the first straight line is the straight line L₃, the second straight line is the straight line L₁, and the third straight line is the straight line L₃₁. The gate traces G₁, G₂, and G₃ are arranged such that the straight lines L₁₂, L₂₃, and L₃₁ do not overlap any of metal portions 150 provided in a plural number when the end portion 118F of the trunk portion 101F is viewed in the −Z direction. As a result of this, weld lines that are generated in middle portions between the gate traces G₁, G₂, and G₃ are generated not in the metal portions 150, that is, not in the vicinity of the proximal ends of the arm portions 103E.

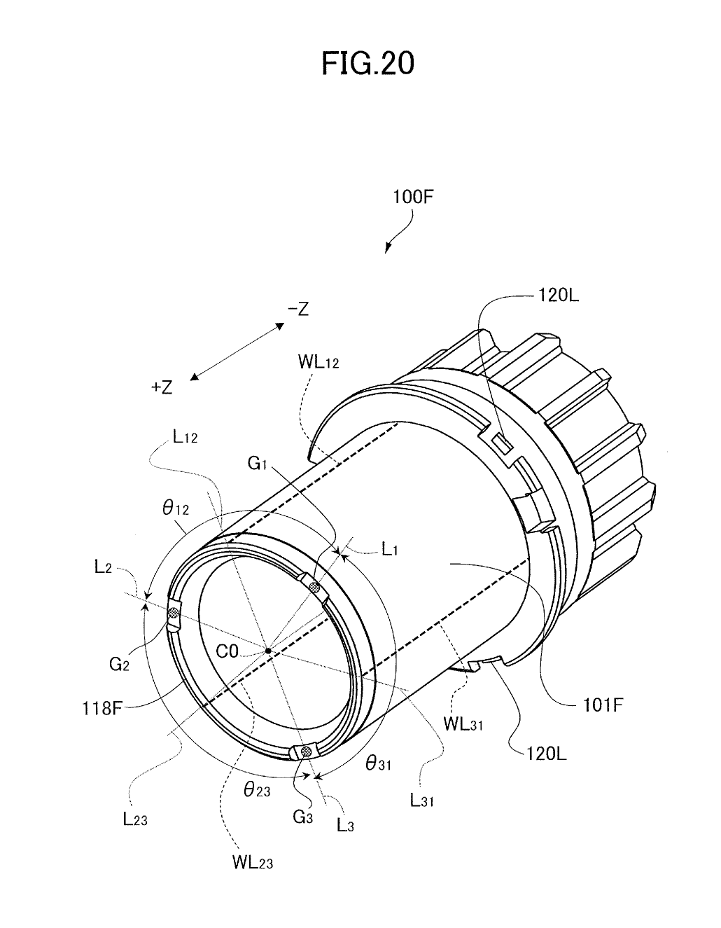

FIG. 20 is a diagram illustrating positions where welds are generated in the transmission member 100F serving as an example of a molded product according to the seventh exemplary embodiment. The phase of the gate traces G₁, G₂, and G₃ with respect to the trunk portion 101F is approximately the same phase as the center positions of cut surfaces 120L of the metal members 120E. Weld lines WL₁₂, WL₂₃, and WL₃₁ generated between the gate traces are generated in the form of straight lines at substantially middle positions bisecting the angles θ₁₂, θ₂₃, and θ₃₁ in the inner circumferential surface and the outer circumferential surface of the trunk portion 101F in directions parallel to the axis C0. Since the weld lines WL₁₂, WL₂₃, and WL₃₁ are not generated in the metal portions 150 of the metal members 120E covered by the resin member 130E, peeling of the resin member 130E from the metal members 120E can be suppressed.

Although a case where the three gate traces G₁, G₂, and G₃ are arranged on the end portion 118F of the trunk portion 101F at approximately equal intervals in correspondence with the three metal portions 150 have been described in the seventh exemplary embodiment, the configuration is not limited to this. The number and length of the metal portions 150 and the number of points of the gate traces may be arbitrarily selected. The gate traces do not have to be arranged at equal intervals on the end portion 118F of the trunk portion 101F as long as the straight lines L₁₂, L₂₃, and L₃₁ of adjacent pairs of the gate traces do not overlap the metal portions 150 as viewed in the direction of the axis C0.

### Eighth Exemplary Embodiment

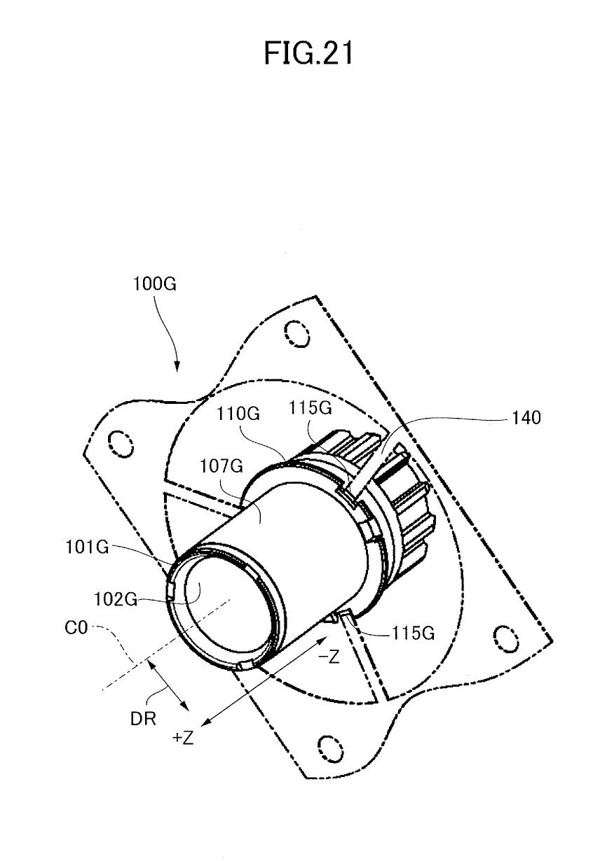

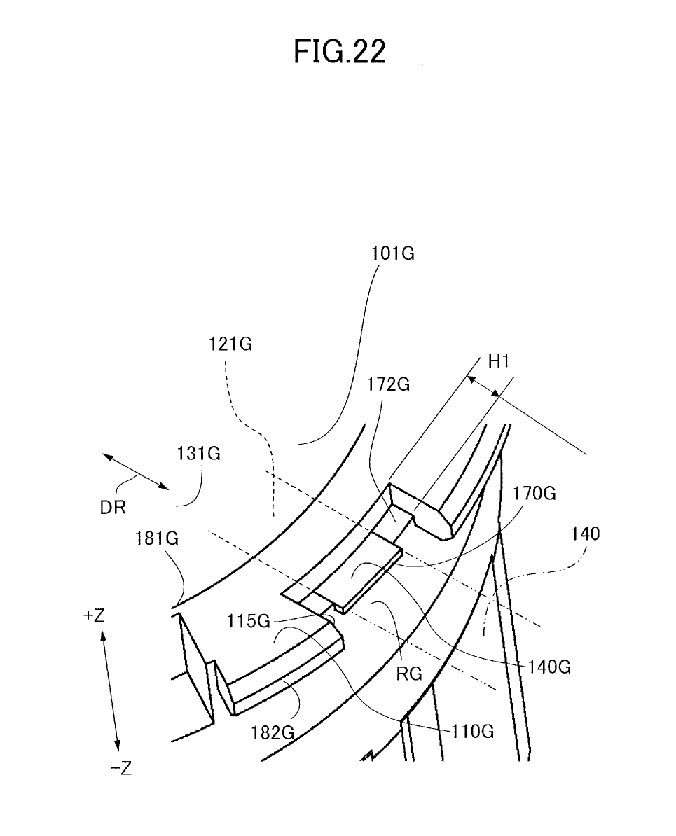

A transmission member serving as an example of a molded product according to an eighth exemplary embodiment will be described. FIG. 21 is a perspective view of a transmission member 100G serving as an example of a molded product according to the eighth exemplary embodiment. FIG. 22 is a partial perspective view of a transmission member 100G serving as an example of a molded product according to the eighth exemplary embodiment.

The transmission member 100G includes a cylindrical trunk portion 101G and, although the illustration is omitted, arm portions configured similarly to, for example, the arm portions 103E illustrated in FIGS. 15A and 15B and described in the sixth and seventh exemplary embodiments. As illustrated in FIG. 22, the trunk portion 101G is constituted by metal portions 121G serving as first metal portions and a resin portion 131G serving as a first resin portion. As illustrated in FIG. 21, the trunk portion 101G includes an inner circumferential surface 102G serving as a first surface and an outer circumferential surface 107G serving as a second surface.

The transmission member 100G includes a brim portion 110G extending from the outer circumferential surface 107G of the trunk portion 101G in a direction from the inner circumferential surface 102G toward the outer circumferential surface 107G, that is, toward the outside in the radial direction DR perpendicular to the axis C0.

The brim portion 110G includes recess portions 115G recessed in a direction from the outer circumferential surface 107G toward the inner circumferential surface 102G, that is, toward the inside in the radial direction DR. As illustrated in FIG. 22, an end portion 140G of a metal portion 121G projects toward the outside in the radial direction DR with respect to the position of a recess portion 115G such that the end portion 140G is exposed to the outside in an inner space RG in the recess portion 115G. In the brim portion 110G, a portion connected to the outer circumferential surface 107G will be referred to as a root portion 181G, and a portion on the opposite side to the root portion 181G will be referred to as an outer circumferential portion 182G.

By cutting the connecting portion between the metal portion 121G and the support member 140 by the cutting machine 90 illustrated in FIG. 5, the metal portion 121G is separated from the support member 140. A cutting trace 170G is formed in the end portion 140G of the metal portion 121G. The cutting trace 170G is positioned at the inner space RG in the recess portion 115G of the brim portion 110G so as to prevent a person from touching the cutting trace 170G. There is a possibility that a person touches the end portion 140G of the metal portion 121G even if the end portion 140G is positioned in the inner space RG in the recess portion 115G. Therefore, it is preferable that the metal portion 121G is cut at a position as close as possible to the root portion 181G of the brim portion 110G. However, if cutting is performed at a position close to the root portion 181G, cutting blade of the cutting machine 90 may be damaged. In addition, there is a possibility that the root portion 181G is damaged by the cutting blade of the cutting machine 90 or a holding portion that holds the transmission member.

In the eighth exemplary embodiment, the brim portion 110G includes step portions 172G that come into contact with the end portions 140G of the metal portions 121G in the inner spaces RG of the recess portions 115G in the thickness direction of the brim portion 110G, specifically the ±Z direction in which the axis C0 extends. Further, parts of the end portions 140G slightly project toward the outside in the radial direction DR with respect to the step portions 172G. The length H1 of the step portions 172G in the radial direction DR may be appropriately set such that the step portions 172G do not project toward the outside in the radial direction DR with respect to the outer circumferential portion 182G, and may be set to, for example, 0.58 mm.

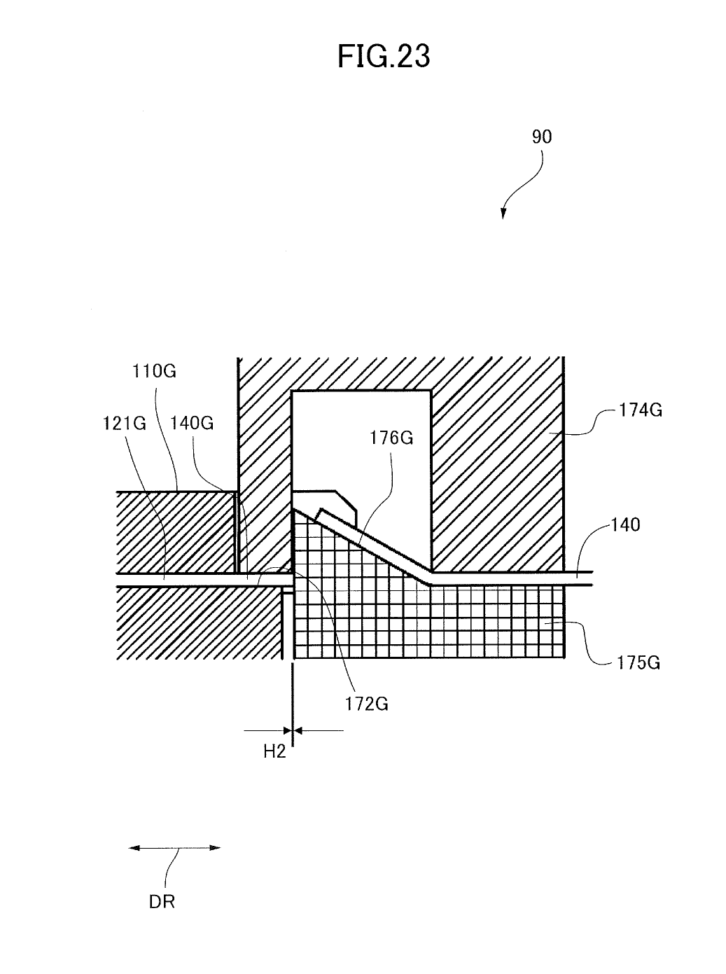

The specific configuration of cutting blades of the cutting machine 90 will be described. FIG. 23 is a section view of cutting blades 174G and 175G of the cutting machine 90. FIG. 23 illustrates a state in which the connection portion between the metal portion 121G and the support member 140 is being cut by the cutting blades 174G and 175G. The cutting blades 174G and 175G are arranged with a minute gap H2 therebetween by an unillustrated mold component of the cutting machine 90. The gap H2 is provided as punching clearance. The gap H2 is preferably 10% to 20% of the thickness of the metal portion 121G. For example, in the case where the thickness of the metal member 120G is 0.2 mm, the gap H2 is preferably 0.02 mm to 0.4 mm. The cutting blade 175G includes a slope portion 176G, and cuts the end portion 140G of the metal portion 121G while bending the support member 140 so as to suppress generation of fragments of metal at the time of cutting. As a result of this, the transmission member 100G is separated from the support member 140.

The end portion 140G of the metal portion 121G is supported by the step portion 172G, nipped by the step portion 172G and the cutting blade 174G, and cut by the cutting blade 175G. In addition, the cutting blade 175G is prevented from coming into contact with the trunk portion 101G or the brim portion 110G. As a result of this, breakage of the cutting blades 174G and 175G such as nicking can be suppressed, and damage to the transmission member 100G, particularly to the trunk portion 101G, can be suppressed.

### Ninth Exemplary Embodiment

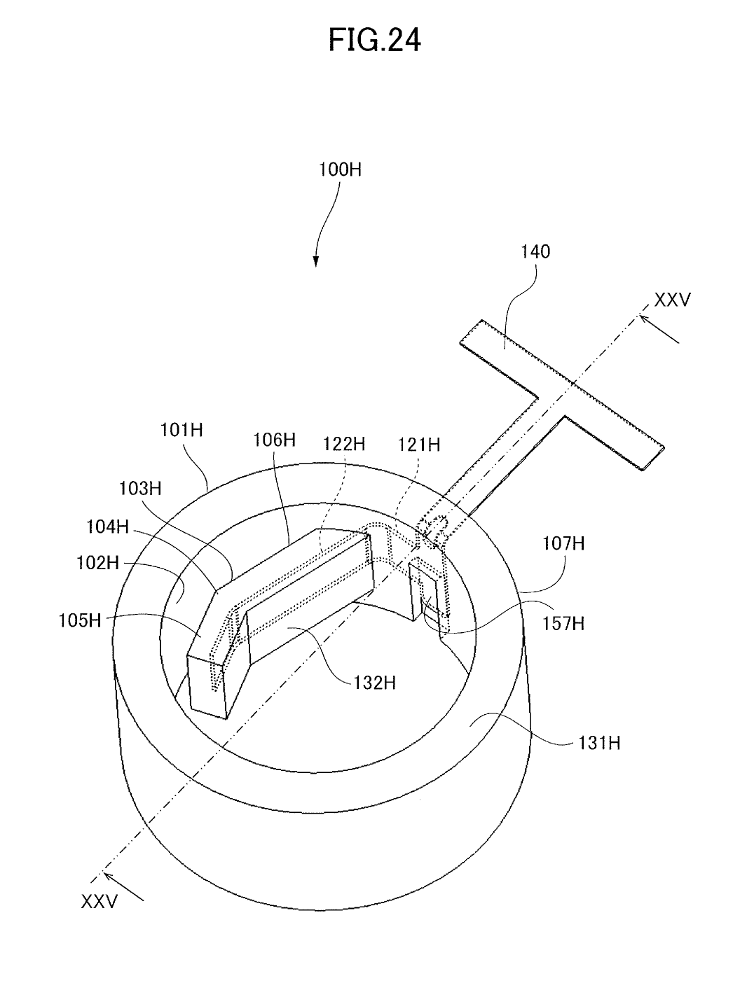

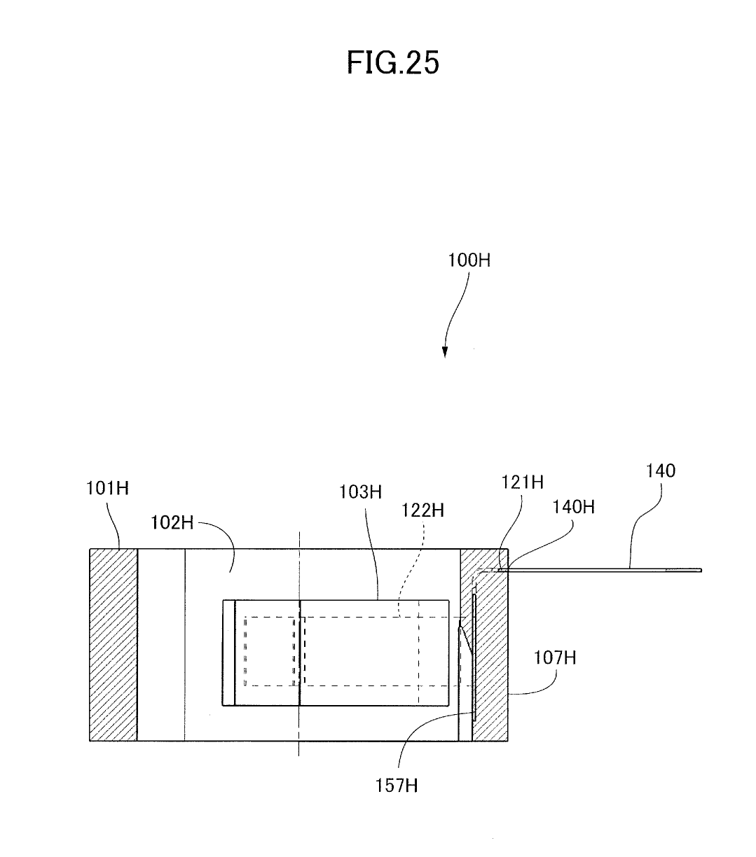

A transmission member serving as an example of a molded product according to a ninth exemplary embodiment will be described. FIG. 24 is a perspective view of a transmission member 100H serving as an example of a molded product. FIG. 25 is a section view of the transmission member 100H taken along a line XXV of FIG. 24.

The transmission member 100H serving as a molded product produced by insert molding includes a cylindrical trunk portion 101H, and an arm portion 103H extending from an inner circumferential surface 102H serving as a first surface of the trunk portion 101H. The trunk portion 101H includes a metal portion 121H serving as a first metal portion, and a resin portion 131H serving as a first resin portion covering the metal portion 121H. The arm portion 103H includes a metal portion 122H serving as a second metal portion extending from the metal portion 121H, and a resin portion 132H serving as a second resin portion covering the metal portion 122H. The metal portion 122H has a shape following the shape of the arm portion 103H. In the trunk portion 101H, an end portion 140H of the metal portion 121H is exposed in an outer circumferential surface 107H serving as a second surface opposite to the inner circumferential surface 102H. To be noted, In FIGS. 24 and 25, the support member 140 is connected to the end portion 140H of the metal portion 121H.

The arm portion 103H includes a straight portion 106H, a bent portion 104H, and a straight portion 105H. An exposing portion 157H is provided in the inner circumferential surface 102H of the trunk portion 101H, and a part of the metal portion 121H is exposed to the outside therethrough.

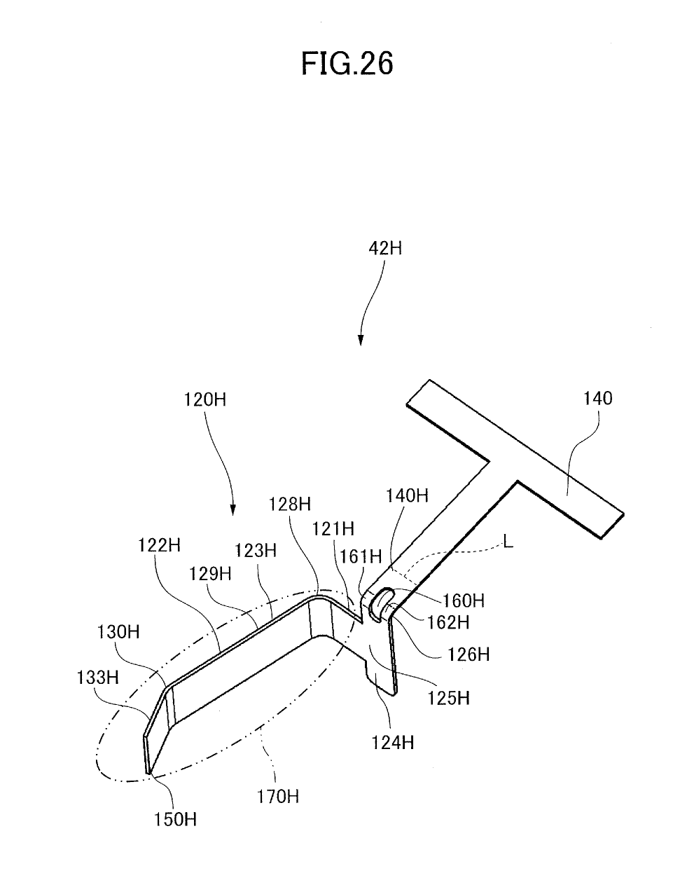

FIG. 26 is a partial perspective view of a pressed hoop material 42H. As illustrated in FIG. 26, the pressed hoop material 42H includes a metal member 120H that is an insert member serving as a constituent of the transmission member 100H and constituted by metal portions 121H and 122H. The hoop material 42H includes the support member 140 that supports one side of the metal portion 121H of the metal member 120H. The metal member 120H and the support member 140 are integrally provided before cutting. The metal member 120H and the support member 140 are cut apart along the broken line L by the cutting machine 90 illustrated in FIG. 5 in a step after injection molding. As a result of this, a proximal end portion 140H that is an end portion, or an end surface, of the metal portion 121H is exposed to the outside through the outer circumferential surface 107H of the trunk portion 101H illustrated in FIGS. 24 and 25.

The metal member 120H includes a body portion 123H and a projection portion 124H. The body portion 123H is formed so as to extend from the support member 140, or the proximal end portion 140H, and the projection portion 124H projects from the body portion 123H. The body portion 123H is bent at a plurality of bent portions 126H, 128H, and 130H by press working. In the body portion 123H, the bent portion 128H is present between the bent portion 126H that is the closest to the proximal end portion 140H and the bent portion 130H that is the closest to a distal end portion 150H of the metal member 120H. The bent portion 126H will be also referred to as a proximal bent portion, the bent portion 128H will be also referred to as an intermediate bent portion, and the bent portion 130H will be also referred to as a distal bent portion. An L-shaped crank portion 125H is disposed between the proximal bent portion 126H and the intermediate bent portion 128H. The projection portion 124H is disposed so as to project from the L-shaped crank portion 125H.

The proximal end portion 140H of the metal member 120H, that is, of the body portion 123H in the extending direction thereof is a fixed end connected to the support member 140, and the distal end portion 150H of the metal member 120H, that is, of the body portion 123H in the extending direction thereof is a free end. The proximal bent portion 126H, the intermediate bent portion 128H, and the distal bent portion 130H are arranged in this order from the proximal end portion 140H toward the distal end portion 150H.

The bent portions 126H and 128H and the L-shaped crank portion 125H are parts of the metal portion 121H serves as a constituent of the trunk portion 101H. The metal portion 122H serving as a constituent of the arm portion 103H includes a straight portion 129H, the distal bent portion 130H, and a straight portion 133H arranged in this order from the intermediate bent portion 128H toward the distal end portion 150H. Hereinafter, a portion of the metal member 120H further on the distal end side than the L-shaped crank portion 125H, that is, a portion circled by a two-dot line in FIG. 26, will be referred to as a metal portion 170H.

The bent portions 126H and 128H, the L-shaped crank portion 125H, and the projection portion 124H are covered by the resin portion 131H in the trunk portion 101H illustrated in FIG. 24. A part of the L-shaped crank portion 125H and a part of the projection portion 124H are exposed through an exposing portion 157H illustrated in FIG. 24. To be noted, although the intermediate bent portion 128H is covered by the resin portion 131H in the trunk portion 101H illustrated in FIG. 24, the intermediate bent portion 128H may be included in the arm portion 103H and covered by the resin portion 132H.

A through hole 160H is defined in the proximal bent portion 126H. A pair of connecting portions 161H and 162H are provided at both end portions of the through hole 160H in the transverse direction. The connecting portion 161H of the pair of connecting portions 161H and 162H is disposed on the side to which the body portion 123H, or the L-shaped crank portion 125H, extends.

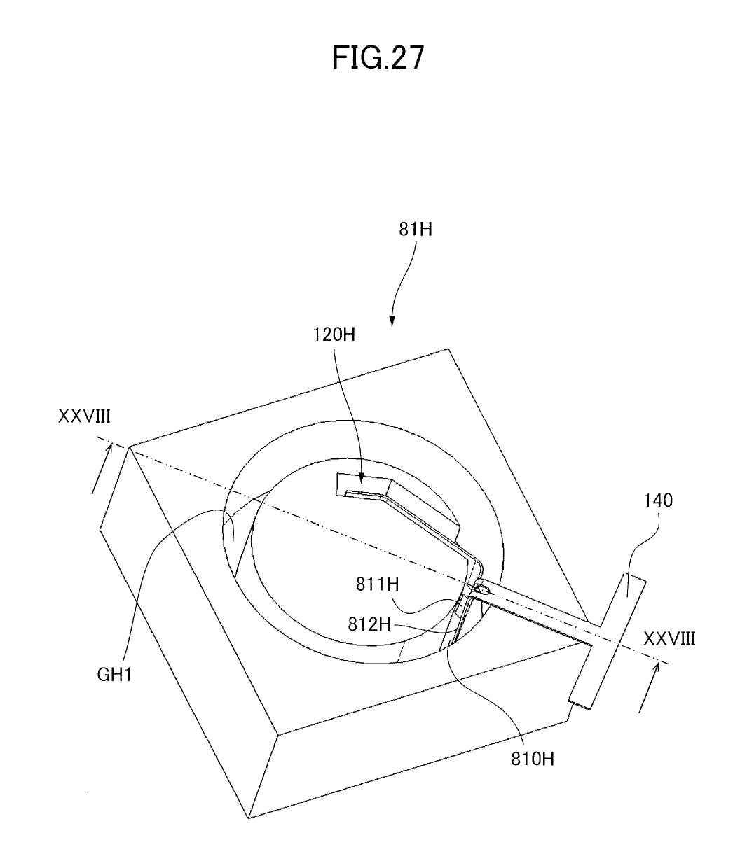

Next, the mold for insert molding will be described. The mold includes a pair of molds. FIG. 27 is a perspective view of the metal member 120H disposed in a mold 81H that is one of the pair of molds. The mold 81H includes a groove portion GH1 that is a part of a cavity defined with the other of the pair of molds.

A positioning portion 810H for positioning the metal member 120H is disposed at a position corresponding to the exposing portion 157H illustrated in FIG. 24 in the groove portion GH1 of the mold 81H. The shape of the positioning portion 810H is the same as the shape of the exposing portion 157H. The positioning portion 810H includes a tapered surface 811H and a straight surface 812H. The tapered surface 811H has an effect of guiding the metal member 120H to a predetermined position by the tapered shape when positioning the metal member 120H. The angle and amount of the taper is determined in accordance with the mold durability of the tapered surface 811H, the amount of displacement caused by the variation of working precision of the metal member, or the like.

### Example 1

An example of producing the transmission member 100H according to the ninth exemplary embodiment will be described as Example 1. The transmission member 100H serving as a molded product was produced such that the outer diameter thereof is φ30 mm, the inner diameter thereof is φ18 mm, and the height thereof is 11 mm. POM (resin contraction rate: 18/1000) was used as the material. The thickness of the metal member 120 was set to 0.2 mm, and SUS304 was used as the material for the metal member 120H.

The bending angle of the proximal bent portion 126H was set in the range of 90° to 93°. By setting the bending angle in this range, the projection portion 124H can be securely brought into contact with the tapered surface 811H at the time of disposing the metal member 120H in the mold 81H. To be noted, the bending angle of the intermediate bent portion 128H was set to 75°, and the bending angle of the distal bent portion 130H was set to 34°.

The widths of the proximal bent portion 126H, the L-shaped crank portion 125H, and the projection portion 124H were set to 2 mm. The amount of projection of the projection portion 124H from the L-shaped crank portion 125H was set to 2 mm.

The through hole 160H was an elongated hole, and the width thereof in the transverse direction was set to 0.8 mm. The length of the proximal bent portion 126H in the longitudinal direction before bending was set to 3.5 mm. The center of the through hole 160H in the width direction was set to coincide with the center of the proximal bent portion 126H in the width direction. The widths of the connecting portions 161H and 162H were each set to 0.6 mm. The width of the positioning portion 810H was set to 2 mm, which is the same as the width of the L-shaped crank portion 125H.

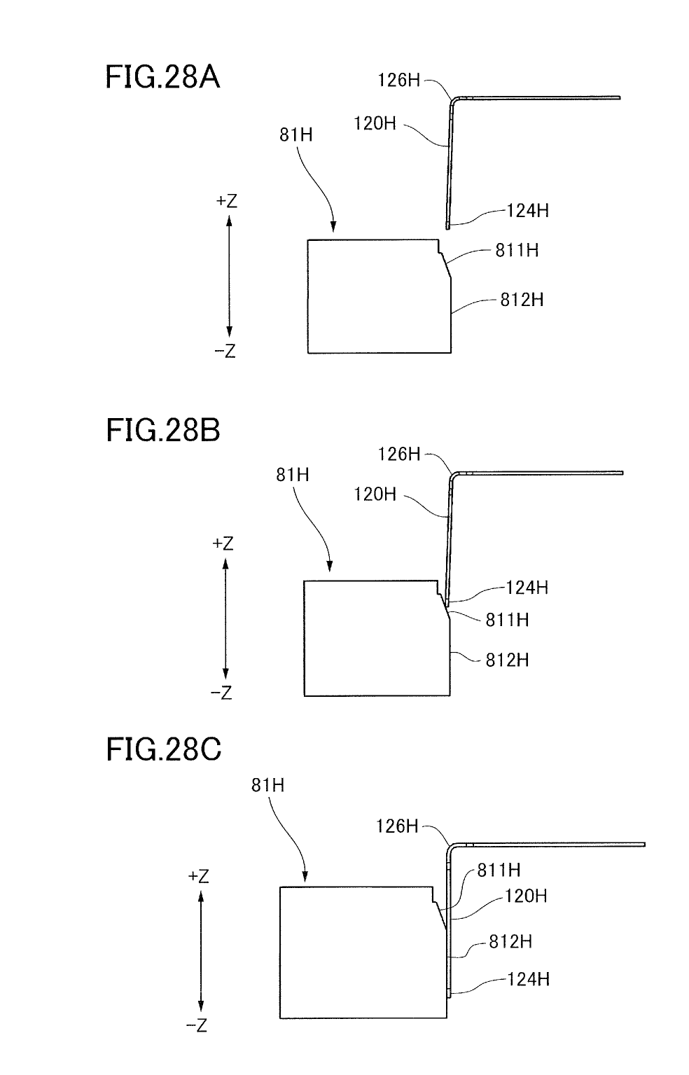

Next, a process of disposing the metal member 120H in the mold 81H will be described. FIGS. 28A, 28B, and 28C are section views of the mold 81H taken along a line XXVIII of FIG. 27. The angle of the tapered surface 811H was set to 20°, and the amount of taper was set to 0.6 mm from the straight surface 812H in the Z direction.

FIG. 28A illustrates a state before the metal member 120H is disposed in the mold 81H. The metal member 120H is disposed at a position in the +Z direction from the mold 81H, that is, above the mold 81H, and is disposed such that an outer side surface of the proximal bent portion 126H and the straight surface 812H are on the same plane. In this state, the metal member 120H is linearly moved in the −Z direction.

FIG. 28B illustrates a state in which the metal member 120H is linearly moved in the −Z direction and the projection portion 124H is brought into contact with the tapered surface 811H. The speed of linearly moving the metal member 120H is 10 mm/sec in the −Z direction. When the projection portion 124H comes into contact with the tapered surface 811H, the load of normal force from the tapered surface 811H is applied to the projection portion 124H, and the load is further transmitted to the connecting portions 161H and 162H in the proximal bent portion 126H illustrated in FIG. 26. The direction of the normal force from the tapered surface 811H is mainly the +Z direction. The metal member 120H includes the metal portion 170H illustrated in FIG. 26, and the proximal bent portion 126H supports one side of the metal portion 170H. A load of deformation of the metal portion 170H due to its weight is also applied to the connecting portions 161H and 162H illustrated in FIG. 26.

The connecting portion 161H closer to the metal portion 170H than the connecting portion 162H receives a larger force of deformation from the weight than the connecting portion 162H does. The force of deformation is applied in the −Z direction by the weight of the metal portion 170H. The normal force from the tapered surface 811H applied to the connecting portions 161H and 162H is applied in such a direction as to cancel the deformation due to the weight of the metal portion 170H. Thus, the connecting portion 161H receives a smaller load than the connecting portion 162H does. As a result of defining the through hole 160H in the proximal bent portion 126H, the second moment of area of the connecting portions 161H and 162H is decreased, and thus the connecting portions 161H and 162H are more likely to be locally deformed. In the case where the metal member 120H is moved in the −Z direction and the projection portion 124H comes into contact with the tapered surface 811H, the connecting portions 161H and 162H are locally deformed. Therefore, the amount of deformation of the metal member 120H, that is, the amount of displacement of the distal end portion 150H from a reference position in the mold 81H, can be reduced.

In the case where the metal member 120H is further moved in the −Z direction, the projection portion 124H is guided to the straight surface 812H by the tapered surface 811H. At this time, the bending angle of the proximal end portion 126H processed to have a bending angle of 90° to 93° is adjusted to 90°. In the case where the metal member 120H is further moved in the −Z direction thereafter, the projection portion 124H comes into contact with the straight surface 812H. Due to the springback caused as a result of adjusting the bending angle of the proximal bent portion 126H to 90°, the projection portion 124H moves in the −Z direction while remaining in contact with the straight surface 812H. As a result of providing the through hole 160H in the proximal bent portion 126H, the orientation of the metal member 120H is maintained even in the case where the projection portion 124H receives frictional resistance by coming into contact with the straight surface 812H. Then, as illustrated in FIG. 28C, placement of the metal member 120H in the mold 81H is completed.

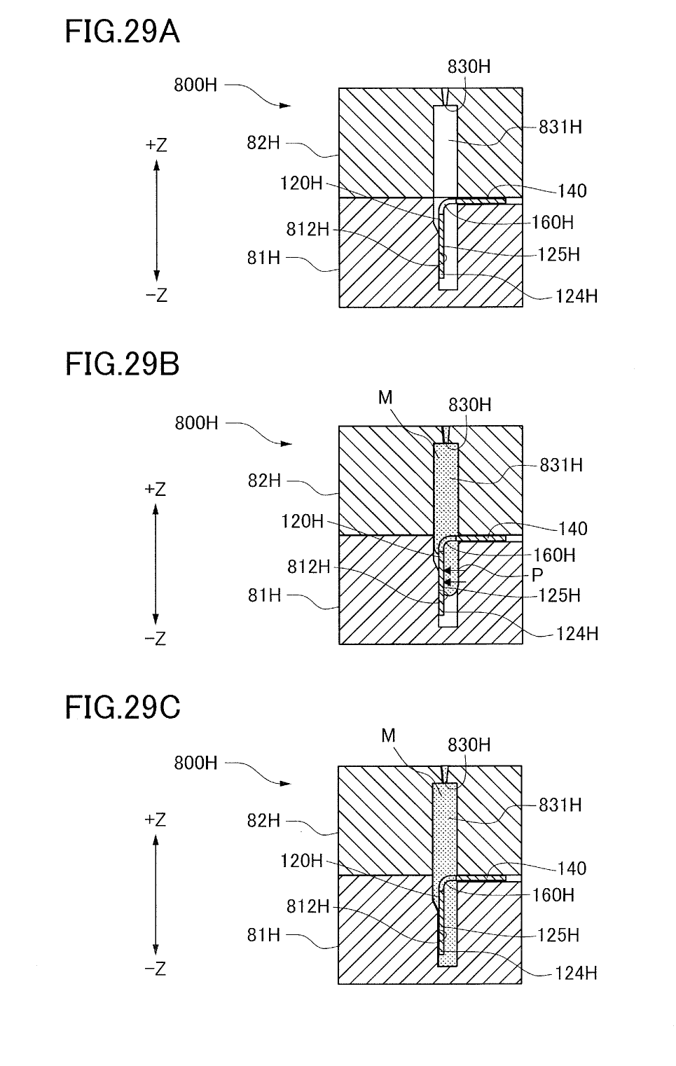

Next, a step of forming a molded product using an injection molding machine will be described. FIGS. 29A, 29B, and 29C are schematic diagrams illustrating a process of producing a molded product by injection molding. As illustrated in FIG. 29A, after disposing the metal member 120H in the mold 81H, a mold for insert molding 800H constituted by molds 81H and 82H is clamped. The support member 140 is held by being nipped between the molds 81H and 82H. By clamping the molds 81H and 82H, a cavity 831H having a shape corresponding to the molded product is defined.

When the molten resin M is injected into the cavity 831H from an injection molding machine through a gate 830H as illustrated in FIG. 29B, injection progresses starting from a thick portion in which injection is easier, and the molten resin M comes into contact with the metal member 120H. The molten resin M passes through the through hole 160H of the metal member 120H and pressurizes the metal member 120H in an arrow P direction such that the L-shaped crank portion 125H and the projection portion 124H come into contact with the straight surface 812H of the mold 81H. In the case where the molten resin M is further injected, the injection progresses as illustrated in FIG. 29C, and full injection in the cavity 831H is completed.

As a result of the molten resin M pressurizing the L-shaped crank portion 125H and the projection portion 124H and bringing the L-shaped crank portion 125H and the projection portion 124H into contact with the straight surface 812H of the mold 81H, the metal member 120H can be positioned and held with respect to the mold 81H. Even in the case where the metal member 120H comes into contact with the straight surface 812H and is deformed, since the connecting portions 161H and 162H illustrated in FIG. 26 are easier to deform, the deformation of the metal portion 170H illustrated in FIG. 26 can be suppressed. According to this, the production yield of the transmission member is improved.

The through hole 160H functions as a flow path for the molten resin M that brings the L-shaped crank portion 125H and the projection portion 124H into contact with the straight surface 812H of the mold 81H. By the pressure of the molten resin M having passed through the through hole 160H, the L-shaped crank portion 125H is pressed against the straight surface 812H. To be noted, it is required to set the thickness between the inner circumferential surface and the outer circumferential surface of the cavity 831H, the position of the metal member 120H, the width of the through hole 160H in the transverse direction, and so forth such that the molten resin M flows through the through hole 160H.

By disposing the through hole 160H such that the entirety of the through hole 160H is disposed inside the cavity 831H, generation of burr caused by the through hole 160H can be suppressed. Among a pair of end portions of the through hole 160H in the longitudinal direction, the end portion on the L-shaped crank portion 125H side is disposed so as not to exceed, in the −Z direction, the position of an end portion of the connecting portion between the L-shaped crank portion 125H and the metal portion 170H in the +Z direction, in order not to reduce the rigidity of the L-shaped crank portion 125H and the metal portion 170H. To be noted, although the through hole 160H is configured as an elongated hole in Example 1, the shape of the through hole 160H is not limited to this. The through hole 160H may be a circular hole, and, in this case, a plurality of circular holes may be disposed so as to overlap one another.

### Example 2

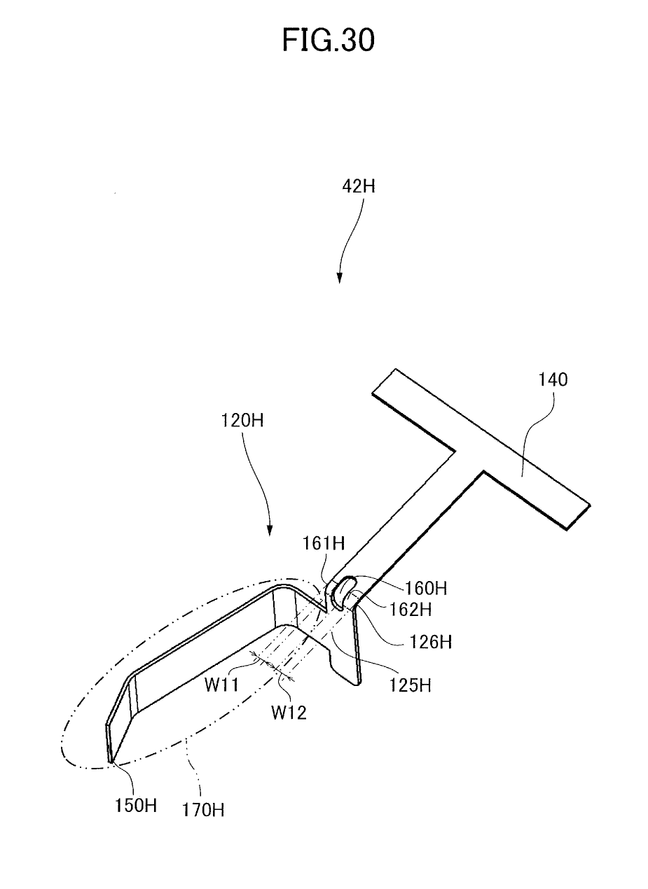

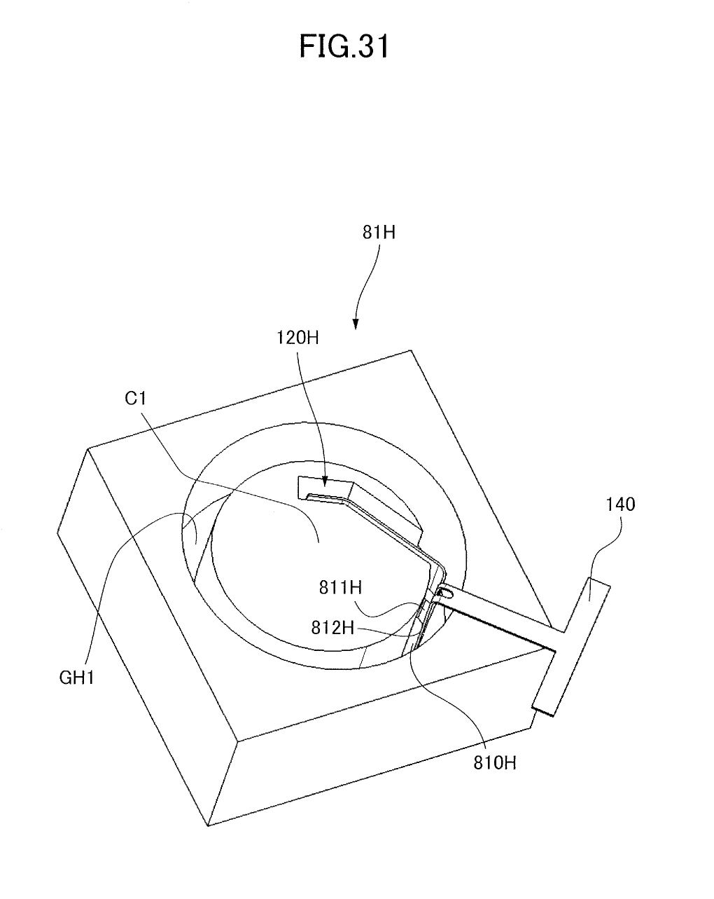

In Example 1, a case where the position of the through hole 160H was set to the center of the proximal bent portion 126H has been described. In Example 2, a case where the through hole 160H was eccentric with respect to the center position in the transverse direction will be described. FIG. 30 is a partial perspective view of the hoop material 42H in Example 2 of the ninth exemplary embodiment. As a result of making the through hole 160H eccentric, width W11 of the connecting portion 161H is different from width W12 of the connecting portion 162H. Other elements than the through hole 160H are the same as in Example 1. FIG. 31 is a perspective view of the metal member 120H disposed in the mold 81H. As illustrated in FIG. 31, the metal member 120H is disposed in the mold 81H.

By changing the position of the through hole 160H in the transverse direction, that is, by making the through hole 160H eccentric, the widths W11 and W12 of the connecting portions 161H and 162H change, and the second moment of area of the connecting portions 161H and 162H change in accordance with the widths. As a result, the position and orientation of the metal member 120H is changed and the metal portion 170H is displaced when the connecting portions 161H and 162H receive a load by disposing the metal member 120H in the mold 81H. As a result of the metal portion 170H being displaced, there is a possibility that the distal end portion 150H of the metal portion 170H interferes with the groove portion GH1 that constitutes the cavity.

The amount of displacement will be described by defining a direction toward a center C1, which is a center of a trunk portion, of the groove portion GH1 that constitutes the cavity as a plus direction and a direction opposite to the direction toward the center C1 as a minus direction. Regarding an allowable range of the amount of displacement of the distal end portion 150H of the metal portion 170H, for example, the lower limit thereof is −0.2 mm and the upper limit thereof is +0.4 mm. In the case where the amount of displacement of a distal end portion 150H deviates from the allowable range, the metal portion 170H may in some case interfere with the groove portion GH1 that constitutes the cavity.

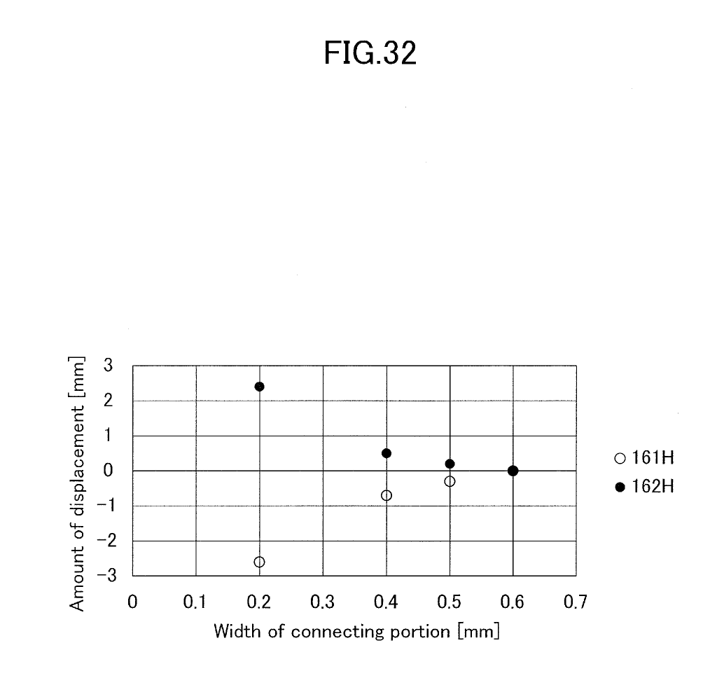

FIG. 32 is a graph showing the relationship between the widths of the connecting portions 161H and 162H and the amount of displacement of the distal end portion 150H of the metal portion 170H in Example 2. In FIG. 32, the amount of displacement of the distal end portion 150H of the metal portion 170H in the case where the width W11 of the connecting portion 161H is set to 0.6 mm that is the same as in Example 1 and the width of the connecting portion 162H is changed between 0.5 mm, 0.4 mm, and 0.2 mm is indicated by hollow circles. Further, the amount of displacement of the distal end portion 150H of the metal portion 170H in the case where the width W12 of the connecting portion 162H is set to 0.6 mm and the width of the connecting portion 161H is changed between 0.5 mm, 0.4 mm, and 0.2 mm is indicated by solid circles. As the widths W11 and W12 of the connecting portions 161H and 162H are decreased, the amount of displacement of the distal end portion 150H is increased.

As can be seen from the graph of FIG. 32, it is preferable that the width W11 of the connecting portion 161H is 0.5 mm or larger and the width W12 of the connecting portion 162H is 0.4 mm or larger. In this condition, interference of the distal end portion 150H with the wall surface defining the cavity can be suppressed.

### Modification Example

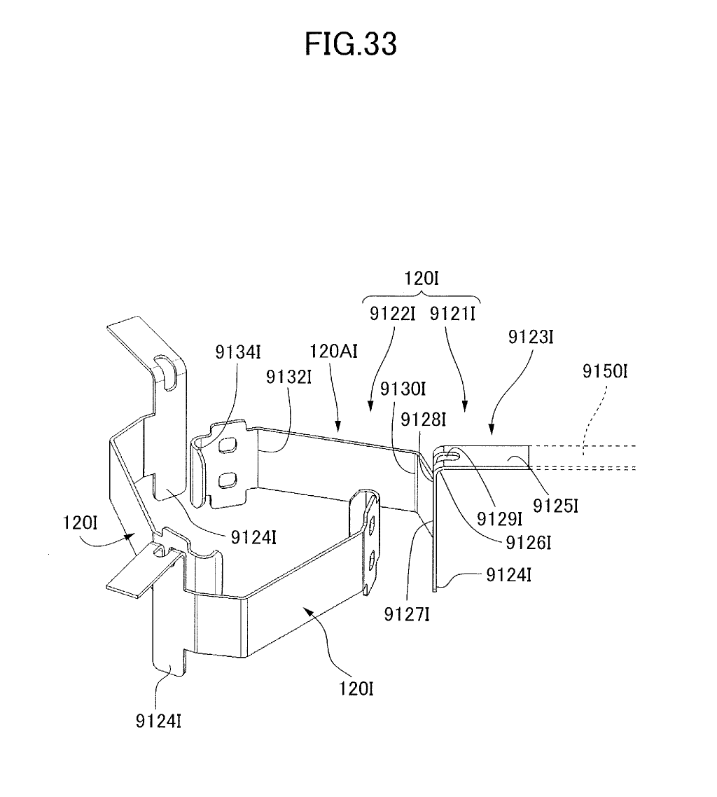

The metal member described in the ninth exemplary embodiment may be applied to the molded product described in the sixth exemplary embodiment or the seventh exemplary embodiment. FIG. 33 is a perspective view of a metal member of a modification example.

Metal members 120I are disposed to be present in both of a trunk portion and arm portions. A metal member 120I includes an arm-shaped body portion 120AI. The body portion 120AI is bent at a plurality of bent portions 9126I, 9128I, 9130I, 9132I, and 9134I by press working. The metal member 120I is constituted by metal portions 9121I and 9122I. The metal portion 9121I serves as a first metal portion that is a constituent of the trunk portion. The metal portion 9122I serves as a second metal portion that is a constituent of an arm portion and extends from the metal portion 9121I.

The metal member 120I includes a projection portion 9124I projecting from the body portion 120AI. The metal portion 9121I serving as a constituent of the trunk portion includes a base portion 9123I that is a part of the body portion 120AI. Thus, the metal portion 9121I includes the projection portion 9124I connected to the base portion 9123I. That is, the projection portion 9124I serves as a constituent of the trunk portion. The projection portion 9124I is disposed to project from the base portion 9123I.

The base portion 9123I includes the bent portions 9126I, 9128I, and 9130I, a connecting portion 9125I, and a flat plate portion 9127I. The bent portion 9126I is provided with a through hole 9129I defined therein. The connecting portion 9125I is a plate-shaped metal material disposed between a support portion 9150I and the bent portion 9126I and connecting the support portion 9150I to the bent portion 9126I. The flat plate portion 9127I is a plate-shaped metal material extending from the bent portion 9126I in an opposite direction to the connecting portion 9125I, and is disposed between the bent portions 9126I and 9128I. The projection portion 9124I is a plate-shaped metal member provided to project from the flat plate portion 9127I between the bent portions 9126I and 9128I. The projection portion 9124I projects from an end of the flat-plate portion 9127I coplanarly with the flat plate portion 9127I. A part or the whole of a surface that is a part of the projection portion 9124I is exposed in the inner circumferential surface of the unillustrated trunk portion. This exposing portion is a portion in which the metal member 120I is not covered as a result of the straight surface 812H of the mold 81H illustrated in FIG. 27 coming into contact with the projection portion 9124I. Therefore, the exposing portion has a shape corresponding to the straight surface 812H of the mold 81H.

Also according to the modification example, the rigidity and creep strength of the arm portions in the molded product can be improved similarly to the sixth and seventh exemplary embodiments.

### Tenth Exemplary Embodiment

A transmission member serving as an example of a molded product according to a tenth exemplary embodiment will be described. To be noted, the configuration of components included in the transmission member other than the metal members is the same as in the sixth and seventh exemplary embodiments, and thus description will be given only for the metal members. A metal member according to the tenth exemplary embodiment has the same shape as the one described in the modification example of the ninth exemplary embodiment.

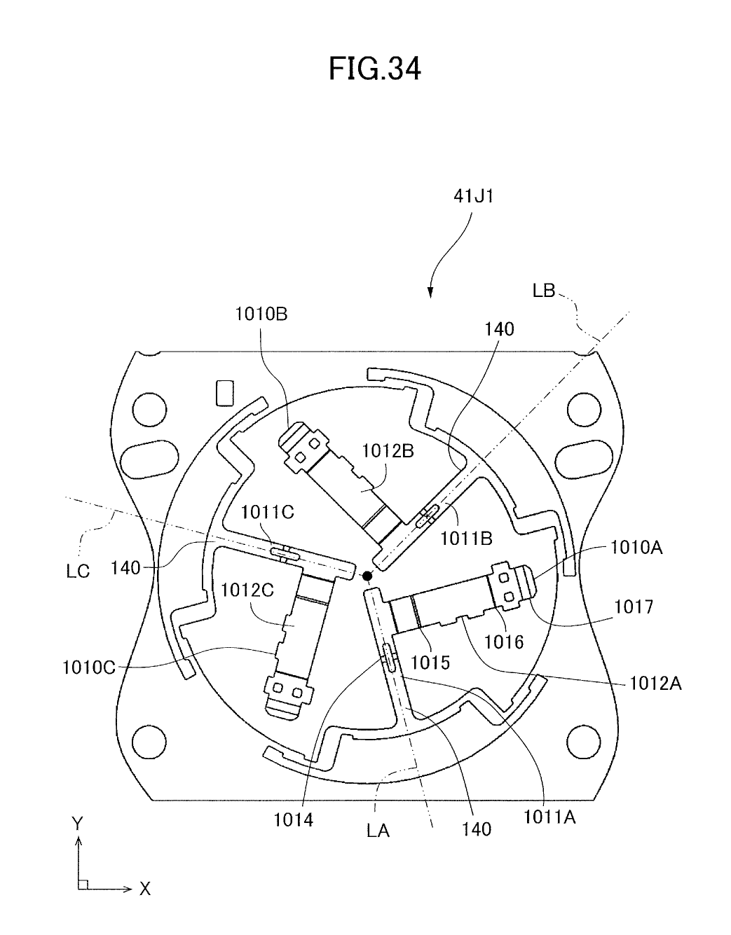

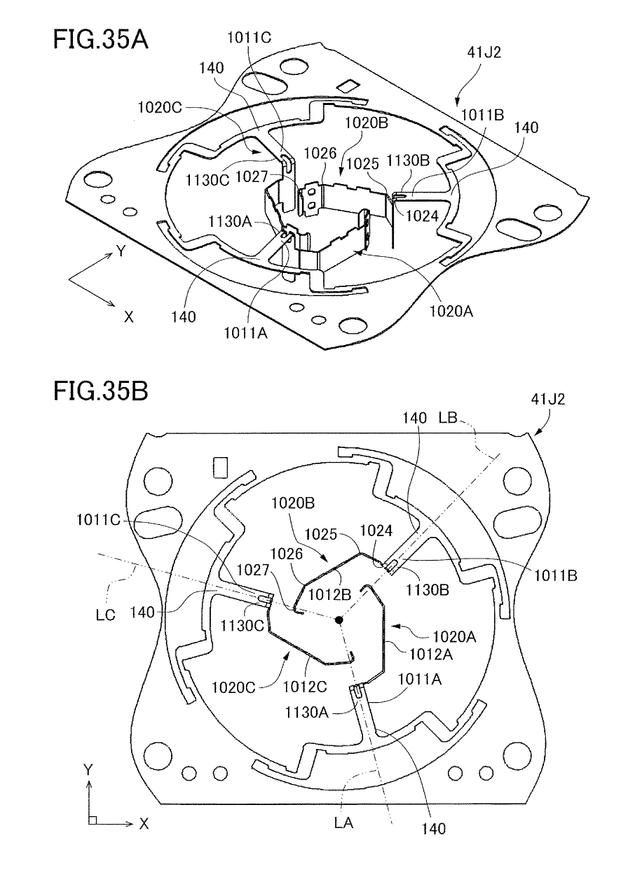

FIG. 34 is a plan view of a hoop material 41J1 serving as a metal material in the tenth exemplary embodiment. FIG. 35A is a perspective view of a hoop material 41J2 serving as a metal material in the tenth exemplary embodiment, and FIG. 35B is a plan view of the hoop material 41J2 serving as a metal material in the tenth exemplary embodiment.

A hoop material before press working is supplied to the pressing machine 70 illustrated in FIG. 5 by an unillustrated material feeder, and the hoop material is press-worked by the press progressive die 71. The hoop material is a plate-like metal material wound up into a roll shape, and is produced by thinning a metal ingot in a rolling direction.

The hoop material is press-worked by the pressing machine 70, and is turned into the hoop material 41J1 first by being punched into such a shape as illustrated in FIG. 34. Then, the hoop material 41J1 is bent as illustrated in FIGS. 35A and 35B, and thus is turned into the hoop material 41J2. In FIG. 34, the hoop material 41J1 before being bent is subjected to punch working, and thus three L-shaped portions 1010A, 1010B, and 1010C are formed. The three L-shaped portions 1010A, 1010B, and 1010C respectively include metal portions 1011A, 1011B, and 1011C serving as first metal portions and metal portions 1012A, 1012B, and 1012C serving as second metal portions. The L-shaped portions 1010A, 1010B, and 1010C each include portions 1014, 1015, 1016, and 1017. After being bent by press working, the portion 1014 becomes a proximal bent portion, the portion 1015 becomes an intermediate bent portion, the portion 1016 becomes a distal bent portion, and the portion 1017 becomes a claw bent portion. The shapes of the portions 1014, 1015, 1016, and 1017 after being bent are illustrated in FIGS. 35A and 35B.

A bent portion 1024 is formed by bending the portion 1014, a bent portion 1025 is formed by bending the portion 1015, a bent portion 1026 is formed by bending the portion 1016, and a bent portion 1027 is formed by bending the portion 1017. Metal members 1020A, 1020B, and 1020C formed by the processing described above are inserted in a mold that is a mold for insert molding, and are molded into, for example, the transmission member 100E illustrated in FIGS. 14, 15, and 17.

In the case of producing a molded product including the trunk portion 101E and the plurality of arm portions 103E extending from the trunk portion 101E as illustrated in FIG. 15A, the three L-shaped portions illustrated in FIG. 34 need to be processed such that the angles of the bent portions are equal. However, in the case where press working is performed such that the metal material is bent perpendicularly to a rolling direction X, that is, the directions of lines of bending of the bent portions are perpendicular to the rolling direction X, large residual stress remains after the press working. At the time of molding, the residual stress in the bent portions is released by heat applied from the resin, and the bent portions are opened to a great extent. Conversely, in the case where press working is performed such that the metal material is bent parallel to the rolling direction X, that is, the directions of lines of bending of the bent portions are parallel to the rolling direction X, the residual stress after press working is small. Therefore, the bent portions are hardly opened.

Center lines of the respective metal portions 1011A, 1011B, and 1011C of the three L-shaped portions 1010A, 1010B, and 1010C are defined as center lines LA, LB, and LC. In the present exemplary embodiment, the three L-shaped portions are formed such that the center lines LA, LB, and LC extend in directions intersecting the rolling direction X of the hoop material 41J1 from which the metal portions 1011A, 1011B, and 1011C are formed and a direction Y perpendicular to the rolling direction X. According to this, occurrence of variation of angles of the bent portions between the three L-shaped portions 1010A, 1010B, and 1010C can be suppressed.

The metal members 1020A, 1020B, and 1020C formed by press working described above are covered by, for example, the resin portion of the trunk portion 101E illustrated in FIG. 15A in subsequent injection molding. The metal portions 1011A, 1011B, and 1011C include straight line portions 1130A, 1130B, and 1130C illustrated in FIG. 35B that are provided so as to extend toward, for example, the end portion 140E illustrated in FIG. 15A. The three straight line portions 1130A, 1130B, and 1130C extend in the directions in which the center lines LA, LB, and LC extend. Although respective end portions of the straight line portions 1130A, 1130B, and 1130C are connected to the support members 140 in FIGS. 35A and 35B, the straight line portions 1130A, 1130B, and 1130C and the support members 140 will be cut apart in the subsequent cutting step, and the end portions will be exposed to the outside like the end portions 140E illustrated in FIG. 15A.

In the transmission member that is a molded product thus produced, the directions in which the straight line portions 1130A, 1130B, and 1130C of the metal members 1020A, 1020B, and 1020C intersect the rolling direction X and the direction Y perpendicular to the rolling direction X. That is, the directions in which the center lines LA, LB, and LC extend that are the directions in which the straight line portions 1130A, 1130B, and 1130C extend are neither perpendicular to nor parallel to the direction X and the direction Y. According to this, for example, occurrence of variation in the orientations of the arm portions 103E illustrated in FIG. 15B can be suppressed.

### Example 3

As Example 3, a specific example of the tenth exemplary embodiment will be described. A SUS304 material having a thickness of about 0.2 mm was used as a plate-like metal material for the hoop material 41J1 or 41J2. A POM resin Tenac-C LZ-750 manufactured by Asahi Kasei Chemicals Corporation was used as the resin material for forming the trunk portion and the arm portions. The molded product was formed by insert molding.

As illustrated in FIG. 34, the L-shaped portions 1010A, 1010B, and 1010C are arranged at equal intervals of 120° in the circumferential direction. The direction in which the center line LA of the metal portion 1011A of the L-shaped portion 1010A is set to intersect the rolling direction X by an angle of 15°. According to this, as illustrated in FIG. 34, the portions 1014, 1015, 1016, and 1017 can be disposed such that bending is not performed in the direction X or Y. Such a shape is formed by progressive press working. Each metal member is set in the mold for insert molding, and thus the molded product is produced.

In the molded product thus produced, although the bent portions of each arm portion open after molding compared with before molding, the amount of opening can be made constant between the plurality of arm portions.

To be noted, the present invention is not limited to the exemplary embodiments described above, and can be modified in many ways within the technical concept of the present invention. In addition, the effects described in the exemplary embodiments are merely a list of the most preferable effects that can be achieved by the present invention, and the effect of the present invention is not limited to the effects described in the exemplary embodiments.

Although a case where the trunk portion has a cylindrical shape has been described in the exemplary embodiments described above, the shape is not limited to this. For example, the trunk portion may have a flat plate shape.

Although a case where the number of molds is two has been described in the exemplary embodiments described above, the number is not limited to this, and the cavity may be defined by three or more molds.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-055121, filed Mar. 21, 2017, Japanese Patent Application No. 2017-090729, filed Apr. 28, 2017, and Japanese Patent Application No. 2017-247055, filed Dec. 22, 2017, which are hereby incorporated by reference wherein in their entirety.

What is claimed is:

1. A method of producing a molded product, the method comprising:
preparing a mold for insert molding which comprises a plurality of molds and in which a cavity corresponding to a molded product comprising a trunk portion and an arm portion extending from the trunk portion is defined;
disposing an insert member comprising a bent portion and a first extending portion extending from the bent portion in a state in which one side of the insert member is supported in the cavity such that the first extending portion is downstream of the bent portion in a flow direction of molten resin, wherein the mold comprises, on a wall surface defining a space corresponding to the arm portion in the cavity, a first projecting portion that supports a part of a surface of the first extending portion positioned on a major angle side of the bent portion; and
injecting molten resin into the cavity in a state in which the part of the surface of the first extending portion positioned on the major angle side of the bent portion is supported by the first projecting portion.

2. The method of producing a molded product according to claim 1, wherein a tapered surface is provided adjacent to the first projecting portion.

3. The method of producing a molded product according to claim 1,
wherein the mold comprises, on the wall surface, a second projecting portion that supports a part of a surface of the first extending portion positioned on a minor angle side of the bent portion, and
wherein molten resin is injected into the cavity in a state in which the part of the surface of the first extending portion positioned on the minor angle side of the bent portion is supported by the second projecting portion.

4. The method of producing a molded product according to claim 3, wherein a tapered surface is provided adjacent to the second projecting portion.

5. The method of producing a molded product according to claim 3, wherein the second projecting portion supports the first extending portion at a position opposing the first projecting portion with the first extending portion interposed therebetween.

6. The method of producing a molded product according to claim 5,
wherein the plurality of molds comprise:
a first mold comprising the first projecting portion and the second projecting portion; and
a second mold comprising a third projecting portion and a fourth projecting portion,
wherein the third projecting portion supports a part of the surface of the first extending portion positioned on the major angle side of the bent portion at a position different from the first projecting portion in a direction perpendicular to a direction in which the first extending portion extends,
wherein the fourth projecting portion supports a part of the surface of the first extending portion positioned on the minor angle side of the bent portion at a position different from the second projecting portion in a direction perpendicular to the direction in which the first extending portion extends, and
wherein molten resin is injected into the cavity in a state in which the first extending portion is supported by the first projecting portion, the second projecting portion, the third projecting portion, and the fourth projecting portion.

7. The method of producing a molded product according to claim 6, wherein positions of the first projecting portion and the second projecting portion in the first mold are displaced from positions of the third projecting portion and the fourth projecting portion in the second mold in the direction in which the first extending portion extends.

8. The method of producing a molded product according to claim 1,
wherein the insert member comprises a second extending portion extending from the bent portion toward an opposite side to the first extending portion,
wherein the mold comprises, on the wall surface, a fifth projecting portion that supports a part of a surface of the second extending portion positioned on the major angle side of the bent portion, and
wherein molten resin is injected into the cavity in a state in which the part of the surface of the second extending portion positioned on the major angle side of the bent portion is supported by the fifth projecting portion.

9. The method of producing a molded product according to claim 8, wherein a tapered surface is provided adjacent to the fifth projecting portion.

10. The method of producing a molded product according to claim 8,
wherein the mold comprises, on the wall surface, a sixth projecting portion that supports a part of a surface of the second extending portion positioned on a minor angle side of the bent portion, and
wherein molten resin is injected into the cavity in a state in which the part of the surface of the second extending portion positioned on the minor angle side of the bent portion is supported by the sixth projecting portion.

11. The method of producing a molded product according to claim 10, wherein a tapered surface is provided adjacent to the sixth projecting portion.

12. The method of producing a molded product according to claim 10, wherein the sixth projecting portion supports the second extending portion at a position opposing the fifth projecting portion with the second extending portion interposed therebetween.

13. The method of producing a molded product according to claim 12,
wherein the plurality of molds comprise:
a first mold comprising the fifth projecting portion and the sixth projecting portion; and
a second mold comprising a seventh projecting portion and an eighth projecting portion,
wherein the seventh projecting portion supports a part of the surface of the second extending portion positioned on the major angle side of the bent portion at a position different from the fifth projecting portion in a direction perpendicular to a direction in which the second extending portion extends,
wherein the eighth projecting portion supports a part of the surface of the second extending portion positioned on the minor angle side of the bent portion at a position different from the sixth projecting portion in a direction perpendicular to the direction in which the second extending portion extends, and
wherein molten resin is injected into the cavity in a state in which the second extending portion is supported by the fifth projecting portion, the sixth projecting portion, the seventh projecting portion, and the eighth projecting portion.

14. The method of producing a molded product according to claim 13, wherein positions of the fifth projecting portion and the sixth projecting portion in the first mold are displaced from positions of the seventh projecting portion and the eighth projecting portion in the second mold in the direction in which the second extending portion extend.

15. A molded product comprising:
a trunk portion comprising a first metal portion and a first resin portion; and
an arm portion extending from the trunk portion and comprising a second metal portion and a second resin portion, the second metal portion extending from the first metal portion,
wherein the second metal portion comprises a bent portion and a first extending portion extending from the bent portion toward a distal end side of the arm portion, and
wherein the arm portion comprises a first exposing portion that exposes a part of a surface of the first extending portion positioned on a major angle side of the bent portion.

16. The molded product according to claim 15, wherein the arm portion comprises a second exposing portion that exposes a part of a surface of the first extending portion positioned on a minor angle side of the bent portion.

17. The molded product according to claim 16, wherein the first exposing portion and the second exposing portion are connected to each other at their end portions in a direction perpendicular to a direction in which the first extending portion extends.

18. The molded product according to claim 16,
wherein the arm portion comprises a third exposing portion and a fourth exposing portion,
wherein the third exposing portion exposes a part of the surface of the first extending portion positioned on the major angle side of the bent portion at a position different from the first exposing portion in a direction perpendicular to a direction in which the first extending portion extends, and
wherein the fourth exposing portion exposes a part of the surface of the first extending portion positioned on the minor angle side of the bent portion at a position different from the second exposing portion in a direction perpendicular to the direction in which the first extending portion extends.

19. The molded product according to claim 18, wherein positions of a pair of the first exposing portion and the second exposing portion are displaced from positions of a pair of the third exposing portion and the fourth exposing portion in the direction in which the first extending portion extends.

20. The molded product according to claim 15,
wherein the second metal portion comprises a second extending portion that extends from the bent portion toward a proximal end side of the arm portion, and
wherein the arm portion comprises a fifth exposing portion that exposes a part of a surface of the second extending portion positioned on the major angle side of the bent portion.

21. The molded product according to claim 20, wherein the arm portion comprises a sixth exposing portion that exposes a part of a surface of the second extending portion positioned on a minor angle side of the bent portion.

22. The molded product according to claim 21, wherein the fifth exposing portion and the sixth exposing portion are connected to each other at their end portions in a direction perpendicular to a direction in which the second extending portion extends.

23. The molded product according to claim 21,
wherein the arm portion comprises a seventh exposing portion and an eighth exposing portion,
wherein the seventh exposing portion exposes a part of the surface of the second extending portion positioned on the major angle side of the bent portion at a position different from the fifth exposing portion in a direction perpendicular to the direction in which the second extending portion extends, and
wherein the eighth exposing portion exposes a part of the surface of the second extending portion positioned on the minor angle side of the bent portion at a position different from the sixth exposing portion in a direction perpendicular to the direction in which the second extending portion extends.

24. The molded product according to claim 23, wherein positions of a pair of the fifth exposing portion and the sixth exposing portion are displaced from positions of a pair of the seventh exposing portion and the eighth exposing portion in the direction in which the second extending portion extends.

25. The molded product according to claim 15,
wherein the trunk portion has a cylindrical shape, and
wherein the arm portion extends from an inner circumferential surface of the trunk portion.

26. The molded product according to claim 15,
wherein the trunk portion comprises a plurality of gate traces disposed on an end portion thereof,
wherein the plurality of gate traces comprise a first gate trace and a second gate trace adjacent to the first gate trace,
wherein a third straight line bisecting an angle formed by a first straight line and a second straight line does not overlap the first metal portion, and
wherein, in a case where the end portion of the trunk portion is viewed in a direction in which an axis passing through a center of the trunk portion extends, the first straight line extends in a radial direction from the axis and passes through the first gate trace, and the second straight line extends in a radial direction from the axis and passes through the second gate trace.

27. The molded product according to claim 15, further comprising a brim portion projecting from a second surface of the trunk portion opposite to a first surface of the trunk portion on which the arm portion is provided,
wherein the brim portion comprises a recess portion and a step portion, the recess portion being recessed in a direction from the second surface toward the first surface and exposing an end portion of the first metal portion in an inner space thereof, the step portion being in contact with the end portion of the first metal portion in a thickness direction of the brim portion in the inner space of the recess portion.

28. A molded product comprising:
a trunk portion comprising a first metal portion and a first resin portion; and
an arm portion extending from the trunk portion and comprising a second metal portion and a second resin portion, the second metal portion extending from the first metal portion,
wherein, in the first metal portion, a through hole is defined in a bent portion that is the closest to an end portion that is exposed to an outside on an opposite side to the arm portion.

29. A molded product comprising:
a trunk portion comprising a first metal portion and a first resin portion; and
an arm portion extending from the trunk portion and comprising a second metal portion and a second resin portion, the second metal portion extending from the first metal portion,
wherein the first metal portion comprises a straight line portion extending toward an end portion exposed to an outside on an opposite side to the arm portion, and
wherein the straight line portion extends in a direction intersecting a rolling direction of a metal material forming the first metal portion and a direction perpendicular to the rolling direction.

30. A cartridge for an image forming apparatus, the cartridge comprising:
a photosensitive drum; and
the molded product according to claim 15,
wherein the molded product is a transmission member configured to transmit rotational force to the photosensitive drum, and is attached to an end portion of the photosensitive drum in a longitudinal direction.

31. An image forming apparatus comprising:
an image forming apparatus body; and
the cartridge according to claim 30 attached to the image forming apparatus body.
